(19) United States
(12) Patent Application Publication
(10) Pub. No.: US 2024/0010511 A1
(43) Pub. Date: Jan. 11, 2024

(54) METHODS AND COMPOSITIONS FOR SYNTHESIS OF PHOSPHOR AND ITS INCORPORATION IN A POLYMER MATRIX FOR LIGHT CONVERSION

(71) Applicant: SolGo, Inc., Fort Worth, TX (US)

(72) Inventor: Sunil Sahi, Forth Worth, TX (US)

(73) Assignee: SolGro, Inc., Fort Worth, TX (US)

(21) Appl. No.: 17/608,010

(22) PCT Filed: May 1, 2020
(86) PCT No.: PCT/US2020/031057

§ 371 Date: Nov. 2, 2021

Related U.S. Application Data
(60) Provisional application No. 62/842,228, filed on May 2, 2019.

(51) Int. Cl. C01F 17/38; C09K 11/77

(52) U.S. Cl. CPC C01F 17/38; C09K 11/7731

(57) ABSTRACT

The invention relates to methods and compositions for synthesizing a phosphor and preparing a surface-modified phosphor comprising a phosphor, a silica, and a silane, and articles comprising same. The invention also relates to a method of dispersion of the disclosed surface-modified phosphor with a blue emitting agent in a polymer matrix and uses thereof.

### CROSS-REFERENCE TO RELATED APPLICATIONS

This application claims the priority filing benefit of U.S. Provisional Application No. 62/842,228, filed May 2, 2019, which is incorporated herein by reference in its entirety.

### FIELD OF THE INVENTION

The present invention relates to new methods and compositions for synthesis of phosphors and their incorporation in a film, e.g., a polymer matrix. Particularly, sulfide phosphor coated with a silica provides increased stability. And further functionalization of such silica-coated sulfide phosphor with an organosilane improves its dispersion in a polymer matrix. This invention also relates to the incorporation of the surface-modified phosphor, i.e., silica-coated and silane-functionalized phosphor, into a polymer matrix along with a blue emitting agent, e.g., 1,4-bis(5-phenyloxazol-2-yl) benzene (“POPOP”). This invention is well suited for light conversion, particularly in a greenhouse film.

### BACKGROUND OF THE INVENTION

To meet the increased food demands of growing world population, improved technologies to enhance the crop yield are needed. Light is a major source of energy for photosynthetic organisms, such as plants, for growth and development. Plants generally convert solar light into chemical energy for growth. Solar spectrum comprises radiation having wavelengths from UV through visible to IR. Plants use a spectral range of solar radiation from 400 to 700 nanometers, which is known as Photosynthetic Active Radiation (PAR). However, for photosynthesis, plants do not equally absorb all PAR wavelengths. Plants mainly absorb blue and red lights from the solar spectrum for photosynthesis, and wavelengths such as UV and green light are photosynthetically less efficient.

To enhance plant growth and development, it would be advantageous to have a greenhouse film with light conversion properties. A major limitation of traditional greenhouse canopies is that they cannot convert specific solar wavelengths to desired wavelengths for efficient photosynthesis. One way to make the greenhouse films to convert various solar wavelengths into desired wavelengths is to fabricate greenhouse canopies. Phosphors can be used to convert a photosynthetically less efficient wavelength of light from a source into a more desirable wavelength of light. Conventional methods using phosphors in a polymer matrix resulted in aggregation of the phosphors. Such aggregation affects the light converting properties of the phosphors leading to a loss of light transmission through the polymer matrix.

Several conventional methods have been developed to improve the dispersion of inorganic particles in polymeric matrices, however with little success. For example, in situ methods result in very low particle concentrations in a polymer matrix and are limited to oxides and metal particles. And a method that uses ultrasonic energy to disperse inorganic particles into a polymer does not result in a uniform dispersion. Also, ligand exchange methods to disperse semiconductor particles in the polymer are mainly limited to cadmium based semiconductor particles and lead to less transfer yield.

Various methods have been developed for surface coating of phosphors. For example, U.S. Pat. No. 4,585,673 describes a chemical vapor deposition technique. However, chemical vapor deposition is difficult and expensive to get uniform coating on individual phosphor. U.S. Pat. No. 6,120,902 describes radiation curable liquid coating on phosphor to protect against mechanical and chemical damage. However, this method cannot be used for coating individual phosphors. And U.S. Pat. No. 3,875,449 describes a method of encapsulating the phosphors with a protective resin coating. However, this method modifies the luminescent quality of the composite.

Phosphors dispersion in a polymer matrix can be improved by coating an organosilane on the phosphor surface as described in WO 2020/028889. However, a limitation with this method is that phosphors are susceptible to oxidation. Moreover, oxidation of these phosphor particles affect their luminescence properties.

Despite several advances in research in dispersion of phosphors in polymer matrices, there is still a long-felt need for efficacious methods and compositions for stable and uniform dispersion of a broad range of phosphors at high particle concentrations with maintenance of the desired light converting properties of the phosphor. The present invention meets this need. A disclosed article, e.g., greenhouse film, made with the methods and compositions of the present invention has uniformly dispersed surface-modified phosphors at high particle concentration and shows high stability with light converting properties.

### SUMMARY OF THE INVENTION

The present invention is based on the new methods and compositions for synthesis and surface-modification of a phosphor, and its uniform dispersion in a polymer film, and on the finding that when such surface-modified phosphor is incorporated in a polymer film, such as a greenhouse film, with a blue light emitting agent, such as 1,4-bis(5-phenyloxazol-2-yl) benzene (“POPOP”), enhances overall plant growth.

The present invention relates to the synthesis of sulfide phosphors and solution to the problem of phosphors degradation due to oxidation when exposed to environmental conditions as well as the aggregation of sulfide phosphors when embedded into a polymer matrix. And the invention further relates to the incorporation of blue emitting agent 1,4-bis(5-phenyloxazol-2-yl) benzene (“POPOP”) and red emitting surface-modified sulfide phosphor into a polymer matrix as light converting materials.

The phosphors incorporated polymers can be utilized to convert photosynthetically less efficient light, such as UV and green light, into highly efficient blue and red light in greenhouse film to increase plant growth and the crop yield. The sulfide phosphor degradation can be controlled by a protective silica coating on the surface of the phosphor. Silica coating prevents direct exposure of sulfide phosphors to environmental oxygen resulting in longer shelf life. Furthermore, silica is the effective substrate for silane coating. The presence of silica on the surface of sulfide phosphor will provide the necessary hydroxyl groups for silanization, thereby improving the silane coating on the phosphor surface. Since silanes improve the compatibility of inorganic materials with organic materials, silane coating (i.e., functionalization) of silica-coated sulfide phosphor will improve the dispersion of phosphor into a polymer matrix such as greenhouse plastic.

In accordance with the purpose(s) of the present invention, as embodied and broadly described herein, the invention, in one aspect, relates to compositions comprising a surface-modified phosphor comprising a phosphor, a silica, and a silane, methods of making same, and articles comprising same. In another aspect, the invention relates to methods of dispersion of such surface-modified phosphor along with a blue light emitting agent in a polymer matrix.

In one aspect, the present invention relates to a method of synthesizing a phosphor, the method comprises: (a) preparing a phosphor comprising: (i) preparing a phosphor reaction mixture comprising a metal compound, a sulfur compound, a rare earth element, a surfactant, and a solvent; (ii) heating the phosphor reaction mixture; (iii) isolating the phosphor particles from the phosphor reaction mixture; (iv) drying the phosphor particles; and (v) firing the dried phosphor particles.

In various aspects, the present invention also relates to methods of preparing a surface-modified phosphor, the method comprises: (a) preparing a surface-coated phosphor comprising: (i) preparing a micelle with a surfactant and an alkane; (ii) preparing phosphor mixture comprising a phosphor and a micelle with a surfactant and an alkane; (iii) preparing a surface-coating solution comprising a silicate, ammonia, and water; (iv) preparing a surface-coating phosphor reaction mixture by mixing the phosphor mixture and the surface-coating solution; (v) stirring the surface-coating phosphor reaction mixture at room temperature; (vi) isolating the surface-coated phosphor particles; and (c) preparing a functionalized surface-coated phosphor comprising: (i) preparing the surface-coated phosphor mixture comprising the surface-coated phosphor and an alcohol; (ii) preparing a functionalization solution comprising a silane functional agent and acidic water; (iii) preparing a functionalization surface-coated phosphor reaction mixture by mixing the surface-coated phosphor mixture and the functionalization solution; (iv) isolating the functionalized surface-coated phosphor particles; (v) drying functionalized surface-coated phosphor particles; and thereby forming the surface-modified phosphor.

One aspect of the invention relates to a method for dispersion of the silica-coated and silane-functionalized (“surface-modified”) phosphor in a polymer film, such as greenhouse film.

Another aspect of the invention relates to a method for dispersion of the surface-modified phosphor along with a blue emitting agent in a polymer film, such as greenhouse film.

The dispersion and incorporation of the surface-modified phosphor in a polymer film may be done using a method of extrusion, film casting, solving casting, bulk polymerization, and the like.

One aspect of the invention relates to a method for dispersion and incorporation of the surface-modified phosphor in a polymer film using extrusion.

Another aspect of the present invention relates to surface-modified phosphor compositions prepared by the disclosed methods.

A further aspect of the present invention relates to luminescent articles comprising the surface-modified phosphor compositions.

A further aspect of the present invention relates to greenhouse system comprising the disclosed articles.

A still further aspect of the present invention relates to greenhouse system comprising the disclosed articles along with a blue emitting agent.

A blue emitting agent may be an inorganic or organic agent.

In one aspect of the invention, the blue emitting agent is an organic agent POPOP.

Other methods, features, systems, and advantages of the present invention will be or become apparent to one of ordinary skill in the art upon examination of the following drawings and detailed description. It is intended that all such additional methods, features, systems, and advantages be included within this description, be within the scope of the present invention, and be protected by the accompanying claims. In addition, all optional and preferred features and modifications of the described aspects are usable in all aspects of the invention taught herein. Further, the individual features of the dependent claims, as well as all optional and preferred features and modifications of the described aspects and embodiments are combinable and interchangeable with one another.

The present invention further relates to the use of the surface-modified phosphors according to the invention for lighting and converting one wavelength of light to another wavelength of light, including, but not limited to, in indoor and outdoor farming, greenhouses, light emitting diodes, display technology, smart windows, other light converting applications, and the like.

### BRIEF DESCRIPTION OF THE FIGURES

The foregoing aspects and advantages of this invention may become apparent from the following detailed description with reference to the accompanying drawings. The components in the drawings are not necessarily to scale; emphasis is instead being placed upon clearly illustrating the principles of the present invention. And, in the drawings, like reference numerals designate corresponding parts throughout the several views.

FIG. 1 shows a schematic representation of silica coating and silane functionalization of Cas:Eu²⁺ phosphor.

FIG. 2 shows a schematic representation of dispersion and incorporation of a surface-modified phosphor (i.e., silica-coated and silane-functionalized CaS:Eu²⁺ phosphor) into a greenhouse plastic through extrusion.

FIG. 3 shows an X-ray diffraction pattern of CaS:Eu²⁺ particles prepared using methods and compositions disclosed herein.

FIG. 4 shows a representative photoluminescence emission and excitation spectra for CaS:Eu²⁺ phosphor particles before coating and functionalization. Inset shows the image of phosphor under UV light.

FIG. 5 shows representative Fourier transform infrared (FTIR) spectra of CaS:Eu²⁺ phosphor particles before and after coating with silica and silane.

FIG. 6 shows representative photoluminescence emission (PL) and excitation (PLE) spectra of CaS:Eu²⁺ phosphor before and after silica-coating and silane-functionalization.

FIG. 7 shows representative photoluminescence emission (PL) and excitation (PLE) spectra of a disclosed luminescent article comprising a silica-coated and silane-functionalized CaS:Eu²⁺ phosphor in an acrylic film.

FIGS. 8A-8B show representative photographic images of silica-coated and silane-functionalized CaS:Eu²⁺ phosphors in an acrylic film under (A) ambient room light and (B) UV light.

FIG. 9 shows representative photoluminescence data of silica-coated and silane-functionalized CaS:Eu²⁺ phosphor particles before and after 1500 hr (equivalent to 1.5 years) of Xenon-arc weathering test.

FIG. 10 shows representative photoluminescence emission and excitation spectra of blue emitting agent, 1,4-bis(5-phenyloxazol-2-yl) benzene (POPOP), in an acrylic film.

FIG. 11 shows representative photographic image of blue emitting POPOP in an acrylic film under (A) ambient room light and (B) UV light.

FIG. 12 shows representative photoluminescence emission spectra of a disclosed article with silica-coated and silane-functionalized CaS:Eu²⁺ phosphor and blue emitting POPOP in a polymer at 365 nm excitation and 485 nm excitation.

FIGS. 13A-13B show representative photographic images of a disclosed article with a red emitting surface-modified (i.e., silica-coated and silane-functionalized) CaS:Eu²⁺ phosphor and blue emitting POPOP in an acrylic film under (A) ambient room light and (B) UV light.

Additional advantages of the invention will be set forth in part in the description below, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE INVENTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

The materials, compounds, compositions, articles, and methods described herein may be understood more readily by reference to the following detailed description of specific aspects of the disclosed subject matter and the Examples included therein.

Many modifications and other aspects disclosed herein will come to mind to one of ordinary skill in the art to which the disclosed compositions and methods pertain having the benefit of the teachings presented in the foregoing descriptions and the associated figures. Therefore, it is to be understood that the inventions are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this invention and to be encompassed by the claims herein.

Although specific terms are employed herein, they are used in a generic and descriptive sense only and not for purposes of limitation.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or description that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All percentages, ratios and proportions herein are by weight, unless otherwise specified. All temperatures are in degrees Celsius (° C.) unless otherwise specified. Unless otherwise specified, temperatures referred to herein are based on atmospheric pressure (i.e. one atmosphere).

All publications mentioned herein are hereby incorporated herein by reference for the purpose of disclosing and describing, for example, the methods and/or materials that are described in the publications which might be used in connection with the presently described invention. The publications discussed herein are provided solely for their disclosure prior to the filing date of the present application. Nothing herein is to be construed as an admission that the present invention is not entitled to antedate such disclosure by virtue of prior invention. Further, the dates of publication provided herein can be different from the actual publication dates, which can require independent confirmation.

As used herein, “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

As used herein, “one aspect” or “an aspect” (or the like) means that a particular feature, structure, or characteristic described in connection with the aspect is included in at least one aspect. Thus, the appearance of the phrases “in one aspect” or “in an aspect” or the like in various places throughout this specification are not necessarily all referring to the same aspect.

Further, described features, structures, or characteristics may be combined in any suitable manner in one or more embodiments. In the following description, numerous specific details are provided to give a thorough understanding of embodiments. One skilled in the art will recognize, however, that the various embodiments can be practiced without one or more of the specific details, or with other methods, components, materials, etc. In other instances, well known structures, materials, or operations are not shown or described in detail to avoid obfuscation.

While aspects of the present invention can be described and claimed in a particular statutory class, such as the system statutory class, this is for convenience only and one of skill in the art will understand that each aspect of the present invention can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various embodiments of the present invention, the following definitions are provided and should be used unless otherwise indicated. Additional terms may be defined elsewhere in the present invention.

### Definitions

The term “comprising” is to be interpreted as specifying the presence of the stated features, integers, steps, or components as referred to, but does not preclude the presence or addition of one or more features, integers, steps, or components, or groups thereof. Moreover, each of the terms “comprising,” “comprises”, “comprised of,” “including,” “includes,” “included,” “involving,” “involves,” “involved,” and “such as” are used in their open, non-limiting sense and may be used interchangeably. As a result an apparatus that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps. Further, the term “comprising” is intended to include examples and aspects encompassed by the terms “consisting essentially of” and “consisting of.” Similarly, the term “consisting essentially of” is intended to include examples encompassed by the term “consisting of.”

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. The feature or features of one embodiment may be applied to other embodiments, even though not described or illustrated, unless expressly prohibited by this disclosure or the nature of the embodiments.

As used herein, the terms “a,” “an,” and “the” include plural referents unless the context clearly dictates otherwise. Thus, for example, reference to “a silica,” “a silane,” “a phosphor,” “a phosphor material,” “a blue emitting agent,” “a polymer material,” or “a matrix material,” is a reference to, but not limited to, one or more such silicas, silanes, phosphors, phosphor materials, blue emitting agents, or matrix materials, and includes equivalents thereof known to those skilled in the art.

Ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed. It is also understood that when a value is disclosed, then “less than or equal to” the value, “greater than or equal to the value,” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

When a range is expressed, a further embodiment includes from the one particular value and/or to the other particular value. For example, where the stated range includes one or both of the limits, ranges excluding either or both of those included limits are also included in the invention, e.g., the phrase “x to y” includes the range from ‘x’ to ‘y’ as well as the range greater than ‘x’ and less than ‘y’. The range can also be expressed as an upper limit, e.g., “about x, y, z, or less” and should be interpreted to include the specific ranges of ‘about x,’ ‘about y,’ and ‘about z’ as well as the ranges of ‘less than x,’ less than y,’ and ‘less than z’. Likewise, the phrase “about x, y, z, or greater” should be interpreted to include the specific ranges of ‘about x,’ ‘about y,’ and ‘about z’ as well as the ranges of ‘greater than x,’ greater than y,’ and ‘greater than z’. In addition, the phrase “about ‘x’ to ‘y’,” where ‘x’ and ‘y’ are numerical values, includes “about ‘x’ to about ‘y’.”

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

Recitation of ranges of values herein are merely intended to serve as a shorthand method of referring individually to each separate value falling within the range. Unless otherwise indicated herein, and each separate value, as well as intermediate ranges, are incorporated into the specification as if individually recited herein. All methods described herein can be performed in any suitable order unless otherwise indicated herein or otherwise clearly contraindicated by the text.

The terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Values expressed as “greater than” do not include the lower value. For example, when the “variable x” is defined as “greater than zero” expressed as “0<x” the value of x is any value, fractional or otherwise that is greater than zero. Similarly, values expressed as “less than” do not include the upper value. For example, when the “variable x” is defined as “less than 2” expressed as “x<2” the value of x is any value, fractional or otherwise that is less than 2.

As used herein, “electromagnetic radiation” refers to a form of energy containing both electric and magnetic wave components which include ultraviolet (UV), visible, and infrared (IR) radiation.

The term “attached” can refer to covalent or non-covalent interaction between two or more molecules. Non-covalent interactions can include ionic bonds, electrostatic interactions, van der Walls forces, dipole-dipole interactions, dipole-induced-dipole interactions, London dispersion forces, hydrogen bonding, halogen bonding, electromagnetic interactions, π-π interactions, cation-π interactions, anion-π interactions, polar π-interactions, and hydrophobic effects.

The term “effective amount” refers to an amount that is sufficient to achieve the desired modification of a physical property of the composition or material. For example, an “effective amount” of a surface coating material, such as silica, or a functionalization material, such as silane, refers to an amount that is sufficient to achieve the desired improvement in the property modulated by the formulation component, e.g., achieving the desired enhancement of dispersion in a matrix material, such as a polymer while retaining the desired level of photoluminescence. The specific level in terms of wt % in a composition required as an effective amount will depend upon a variety of factors including the amount and type of silica and silane, amount and type of phosphor, amount and type of matrix, and amount and type of blue emitting agent, and end use of the article made using the composition.

The terms “optional” or “optionally” means that the subsequently described event or circumstance can or cannot occur, and that the description includes instances where said event or circumstance occurs and instances where it does not.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Compounds are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this invention belongs.

As used herein, the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

As used herein the terms “volume percent,” “vol %,” “v/v %,” and “vol. %,” which can be used interchangeably, indicate the percent by volume of a given component based on the total volume of the composition, unless otherwise specified. That is, unless otherwise specified, all v/v % values are based on the total volume of the composition. It should be understood that the sum of v/v % values for all components in a disclosed composition or formulation are equal to 100.

As used herein, the term “vol/vol” is a volume ratio in which the first “vol” (numerator) refers to the volume of a component in a solution or mixture and the second “vol” (denominator) refers to the total volume of all components in the solution or mixture.

As used herein, the terms “phosphor powder coated with silica,” “surface-coated phosphor,” “silica-coated phosphor,” and “coated phosphor” can be used interchangeably and refer to the disclosed surface-coated phosphors prepared using the disclosed methods of preparing disclosed surface-coated phosphors, and as further described in the Examples herein.

As used herein, the terms “phosphor powder coated with silica and silane,” “phosphor coated with silica and silane,” “phosphor powder functionalized with silane,” “surface-functionalized and surface-coated phosphor,” “surface-modified,” “surface-treated,” “silica-coated and silane-functionalized phosphor,” “silane-functionalized and silica-coated phosphor,” “silica-coated silane-functionalized phosphor,” “silane-functionalized silica-coated phosphor,” and “functionalized and coated phosphor” can be used interchangeably and refer to the disclosed surface-functionalized and surface-coated phosphors prepared using the disclosed methods of preparing the surface-modified phosphors, and as further described in the Examples herein.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight of component Y, X, and Y are present at a weight ratio of 2:5, and are present in such ratio regardless of whether additional components are contained in the compound.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this invention, the heteroatoms, such as nitrogen, can have hydrogen substituents and/or any permissible substituents of organic compounds described herein which satisfy the valences of the heteroatoms. This invention is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc. It is also contemplated that, in certain aspects, unless expressly indicated to the contrary, individual substituents can be further optionally substituted (i.e., further substituted or unsubstituted).

The term “aliphatic” or “aliphatic group,” as used herein, denotes a hydrocarbon moiety that may be straight-chain (i.e., unbranched), branched, or cyclic (including fused, bridging, and spirofused polycyclic) and may be completely saturated or may contain one or more units of unsaturation, but which is not aromatic. Unless otherwise specified, aliphatic groups contain 1-20 carbon atoms. Aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, a residue of a silica material, refers to the chemical moieties resulting from reaction of a silica with a phosphor. And a residue of a silane material, refers to the chemical moieties resulting from reaction of a silane with a surface-coated phosphor.

The term “alkyl” as used herein is a branched or unbranched saturated hydrocarbon group of 1 to 100 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic or acyclic. The alkyl group can be branched or unbranched. The alkyl group can also be substituted or unsubstituted. For example, the alkyl group can be substituted with one or more groups including, but not limited to, alkyl, cycloalkyl, alkoxy, amino, ether, halide, hydroxy, nitro, silyl, sulfo-oxo, or thiol, as described herein. A “lower alkyl” group is an alkyl group containing from one to six (e.g., from one to four) carbon atoms. The term alkyl group can also be a C1 alkyl, C1-C2 alkyl, C1-C3 alkyl, C1-C4 alkyl, C1-C5 alkyl, C1-C6 alkyl, C1-C7 alkyl, C1-C8 alkyl, C1-C9 alkyl, C1-C10 alkyl, and the like up to and including a C1-C60 alkyl. A “lower alkyl” group is an alkyl group containing from one to six carbon atoms. A “higher alkyl” group is an alkyl group containing from six to about 30 carbon atoms.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” or “haloalkyl” specifically refers to an alkyl group that is substituted with one or more halide, e.g., fluorine, chlorine, bromine, or iodine. Alternatively, the term “monohaloalkyl” specifically refers to an alkyl group that is substituted with a single halide, e.g., fluorine, chlorine, bromine, or iodine. The term “polyhaloalkyl” specifically refers to an alkyl group that is independently substituted with two or more halides, i.e., each halide substituent need not be the same halide as another halide substituent, nor do the multiple instances of a halide substituent need to be on the same carbon. The term “alkoxyalkyl” specifically refers to an alkyl group that is substituted with one or more alkoxy groups, as described below. The term “aminoalkyl” specifically refers to an alkyl group that is substituted with one or more amino groups. The term “hydroxyalkyl” specifically refers to an alkyl group that is substituted with one or more hydroxy groups. When “alkyl” is used in one instance and a specific term such as “hydroxyalkyl” is used in another, it is not meant to imply that the term “alkyl” does not also refer to specific terms such as “hydroxyalkyl” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The term “heterocycloalkyl” is a type of cycloalkyl group as defined above, and is included within the meaning of the term “cycloalkyl,” where at least one of the carbon atoms of the ring is replaced with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, cycloalkyl, alkoxy, amino, ether, halide, hydroxy, nitro, silyl, sulfo-oxo, or thiol as described herein.

The terms “alkoxy” and “alkoxyl” as used herein to refer to an alkyl or cycloalkyl group bonded through an ether linkage; that is, an “alkoxy” group can be defined as —OA¹ where A¹ is alkyl or cycloalkyl as defined above. “Alkoxy” also includes polymers of alkoxy groups as just described; that is, an alkoxy can be a polyether such as —OA¹-OA² or —OA¹-(OA²)ₐ-OA³, where “a” is an integer of from 1 to 200 and A¹, A², and A³ are alkyl and/or cycloalkyl groups.

The term “alkenyl” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkenyl” as used herein is a non-aromatic carbon-based ring composed of at least three carbon atoms and containing at least one carbon-carbon double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, norbornenyl, and the like. The term “heterocycloalkenyl” is a type of cycloalkenyl group as defined above, and is included within the meaning of the term “cycloalkenyl,” where at least one of the carbon atoms of the ring is replaced with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “aromatic group” as used herein refers to a ring structure having cyclic clouds of delocalized π electrons above and below the plane of the molecule, where the π clouds contain (4n+2) π electrons. A further discussion of aromaticity is found in Morrison and Boyd, Organic Chemistry, (5th Ed., 1987), Chapter 13, entitled “Aromaticity,” pages 477-497, incorporated herein by reference. The term “aromatic group” is inclusive of both aryl and heteroaryl groups.

The term “aryl” as used herein is a group that contains any carbon-based aromatic group including, but not limited to, benzene, naphthalene, phenyl, biphenyl, anthracene, and the like. The aryl group can be substituted or unsubstituted. The aryl group can be substituted with one or more groups including, but not limited to, alkyl, cycloalkyl, alkoxy, alkenyl, cycloalkenyl, alkynyl, cycloalkynyl, aryl, heteroaryl, aldehyde, —NH₂, carboxylic acid, ester, ether, halide, hydroxy, ketone, azide, nitro, silyl, sulfo-oxo, or thiol as described herein. The term “biaryl” is a specific type of aryl group and is included in the definition of “aryl.” In addition, the aryl group can be a single ring structure or comprise multiple ring structures that are either fused ring structures or attached via one or more bridging groups such as a carbon-carbon bond. For example, biaryl to two aryl groups that are bound together via a fused ring structure, as in naphthalene, or are attached via one or more carbon-carbon bonds, as in biphenyl.

The term “aldehyde” as used herein is represented by the formula —C(O)H. Throughout this specification “C(O)” is a short hand notation for a carbonyl group, i.e., C═O.

The terms “amine” or “amino” as used herein are represented by the formula —NA¹A², where A¹ and A² can be, independently, hydrogen or alkyl, cycloalkyl, alkenyl, cycloalkenyl, alkynyl, cycloalkynyl, aryl, or heteroaryl group as described herein. A specific example of amino is —NH₂.

The term “alkylamino” as used herein is inclusive of both monoalkylamino groups and dialkyl aminogroups. Monoalkylamino groups are represented by the formula —NH(-alkyl) where alkyl is a described herein. Representative examples of monoalkylamino groups include, but are not limited to, methylamino group, ethylamino group, propylamino group, isopropylamino group, butylamino group, isobutylamino group, (sec-butyl)amino group, (tert-butyl)amino group, pentylamino group, isopentylamino group, (tert-pentyl)amino group, hexylamino group, and the like. And dialkylamino groups are represented by the formula —N(-alkyl)₂ where alkyl is a described herein. Representative examples of dialkylamino groups include, but are not limited to, dimethylamino group, diethylamino group, dipropylamino group, diisopropylamino group, dibutylamino group, diisobutylamino group, di(sec-butyl)amino group, di(tert-butyl)amino group, dipentylamino group, diisopentylamino group, di(tert-pentyl)amino group, dihexylamino group, N-ethyl-N-methylamino group, N-methyl-N-propylamino group, N-ethyl-N-propylamino group and the like.

The term “carboxylic acid” as used herein is represented by the formula —C(O)OH.

The term “ester” as used herein is represented by the formula —OC(O)A¹ or —C(O)OA¹, where A¹ can be alkyl, cycloalkyl, alkenyl, cycloalkenyl, alkynyl, cycloalkynyl, aryl, or heteroaryl group as described herein. The term “polyester” as used herein is represented by the formula -(A¹O(O)C-A²-C(O)O)ₐ or -(A¹O(O)C-A²-OC(O))ₐ, where A¹ and A² can be, independently, an alkyl, cycloalkyl, alkenyl, cycloalkenyl, alkynyl, cycloalkynyl, aryl, or heteroaryl group described herein and “a” is an integer from 1 to 500. “Polyester” is as the term used to describe a group that is produced by the reaction between a compound having at least two carboxylic acid groups with a compound having at least two hydroxyl groups.

The term “ether” as used herein is represented by the formula A¹OA², where A¹ and A² can be, independently, an alkyl, cycloalkyl, alkenyl, cycloalkenyl, alkynyl, cycloalkynyl, aryl, or heteroaryl group described herein. The term “polyether” as used herein is represented by the formula -(A¹O-A²O)ₐ, where A¹ and A² can be, independently, an alkyl, cycloalkyl, alkenyl, cycloalkenyl, alkynyl, cycloalkynyl, aryl, or heteroaryl group described herein and “a” is an integer of from 1 to 500. Examples of polyether groups include polyethylene oxide, polypropylene oxide, and polybutylene oxide.

The terms “halo,” “halogen” or “halide,” as used herein can be used interchangeably and refer to F, Cl, Br, or I.

“R¹,” “R²,” “R³,” . . . “Rⁿ,” where n is an integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

As described herein, compounds of the invention may contain “optionally substituted” moieties. In general, the term “substituted,” whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable or chemically feasible compounds. It is also contemplated that, in certain aspects, unless expressly indicated to the contrary, individual substituents can be further optionally substituted (i.e., further substituted or unsubstituted).

Suitable monovalent substituents on a substitutable carbon atom of an “optionally substituted” group are independently halogen; —(CH₂)₀₋₄R^{∘}; —(CH₂)₀₋₄OR^{∘}; —O(CH₂)₀₋₄R^{∘}, —O—(CH₂)₀₋₄C(O)OR^{∘}; —(CH₂)₀₋₄CH(OR^{∘})₂; —(CH₂)₀₋₄SR^{∘}; —(CH₂)₀₋₄Ph, which may be substituted with R^{∘}; —(CH₂)₀₋₄O(CH₂)₀₋₁Ph which may be substituted with R^{∘}; —CH═CHPh, which may be substituted with R^{∘}; —(CH₂)₀₋₄O(CH₂)₀₋₁-pyridyl which may be substituted with R^{∘}; —NO₂; —CN; —N₃; —(CH₂)₀₋₄N(R^{∘})₂; —(CH₂)₀₋₄N(R^{∘})C(O)R^{∘}; —N(R^{∘})C(S)R^{∘}; —(CH₂)₀₋₄N(R^{∘})C(O)NR^{∘}₂; —N(R^{∘})C(S)NR^{∘}₂; —(CH₂)₀₋₄N(R^{∘})C(O)OR^{∘}; —N(R^{∘})N(R^{∘})C(O)R^{∘}; —N(R^{∘})N(R^{∘})C(O)NR^{∘}₂; —N(R^{∘})N(R^{∘})C(O)OR^{∘}; —(CH₂)₀₋₄C(O)R^{∘}; —C(S)R^{∘}; —(CH₂)₀₋₄C(O)OR^{∘}; —(CH₂)₀₋₄C(O)SR^{∘}; —(CH₂)₀₋₄C(O)OSiR^{∘}₃; —(CH₂)₀₋₄OC(O)R^{∘}; —OC(O)(CH₂)₀₋₄SR—, SC(S)SR^{∘}; —(CH₂)₀₋₄SC(O)R^{∘}; —(CH₂)₀₋₄C(O)NR^{∘}₂; —C(S)NR^{∘}₂; —C(S)SR^{∘}; —(CH₂)₀₋₄OC(O)NR^{∘}₂; —C(O)N(OR^{∘})R^{∘}; —C(O)C(O)R^{∘}; —C(O)CH₂C(O)R^{∘}; —C(NOR^{∘})R^{∘}; —(CH₂)₀₋₄SSR^{∘}; —(CH₂)₀₋₄S(O)₂R^{∘}; —(CH₂)₀₋₄S(O)₂OR^{∘}; —(CH₂)₀₋₄OS(O)₂R^{∘}; —S(O)₂NR^{∘}₂; —(CH₂)₀₋₄S(O)R^{∘}; —N(R^{∘})S(O)₂NR^{∘}₂; —N(R^{∘})S(O)₂R^{∘}; —N(OR^{∘})R^{∘}; —C(NH)NR^{∘}₂; —P(O)₂R^{∘}; —P(O)R^{∘}₂; —OP(O)R^{∘}₂; —OP(O)(OR^{∘})₂; SiR^{∘}₃; —(C₁₋₄ straight or branched alkylene)O—N(R^{∘})₂; or —(C₁₋₄ straight or branched alkylene)C(O)O—N(R^{∘})₂, wherein each R^{∘} may be substituted as defined below and is independently hydrogen, C₁₋₆ aliphatic, —CH₂Ph, —O(CH₂)₀₋₁Ph, —CH₂-(5-6 membered heteroaryl ring), or a 5-6-membered saturated, partially unsaturated, or aryl ring having 0-4 heteroatoms independently selected from nitrogen, oxygen, or sulfur, or, notwithstanding the definition above, two independent occurrences of R^{∘}, taken together with their intervening atom(s), form a 3-12-membered saturated, partially unsaturated, or aryl mono- or bicyclic ring having 0-4 heteroatoms independently selected from nitrogen, oxygen, or sulfur, which may be substituted as defined below.

Suitable monovalent substituents on R^{•} (or the ring formed by taking two independent occurrences of R^{•} together with their intervening atoms), are independently halogen, —(CH₂)₀₋₂R^{•}, -(haloR^{•}), —(CH₂)₀₋₂OH, —(CH₂)₀₋₂OR^{•}, —(CH₂)₀₋₂CH(OR^{•})₂; —O(haloR^{•}), —CN, —N₃, —(CH₂)₀₋₂C(O)R^{•}, —(CH₂)₀₋₂C(O)OH, —(CH₂)₀₋₂C(O)OR^{•}, —(CH₂)₀₋₂SR^{•}, —(CH₂)₀₋₂SH, —(CH₂)₀₋₂NH₂, —(CH₂)₀₋₂NHR^{•}, —(CH₂)₀₋₂NR^{•}₂, —NO₂, —SiR^{•}₃, —OSiR^{•}₃, —C(O)SR^{•}, —(C₁₋₄ straight or branched alkylene)C(O)OR^{•}, or —SSR^{•} wherein each R^{•} is unsubstituted or where preceded by “halo” is substituted only with one or more halogens, and is independently selected from C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur. Suitable divalent substituents on a saturated carbon atom of R^{•} include ═O and ═S.

Suitable divalent substituents on a saturated carbon atom of an “optionally substituted” group include the following: ═O, ═S, ═NNR^{*}₂, ═NNHC(O)R^{*}, ═NNHC(O)OR^{*}, ═NNHS(O)₂R^{*}, ═NR^{*}, ═NOR^{*}, —O(C(R^{*}₂))₂₋₃O—, or —S(C(R^{*}₂))₂₋₃S—, wherein each independent occurrence of R^{•} is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur. Suitable divalent substituents that are bound to vicinal substitutable carbons of an “optionally substituted” group include: —O(CR^{*}₂)₂₋₃O—, wherein each independent occurrence of R^{•} is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur.

Suitable substituents on the aliphatic group of R^{•} include halogen, —R^{•}, -(haloR^{•}), —OH, —OR^{•}, —O(haloR^{•}), —CN, —C(O)OH, —C(O)OR^{•}, —NH₂, —NHR^{•}, —NR^{•}₂, or —NO₂, wherein each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Suitable substituents on a substitutable nitrogen of an “optionally substituted” group include —R^{†}, —NR^{†}₂, —C(O)R^{†}, —C(O)OR^{†}, —C(O)C(O)R^{†}, —C(O)CH₂C(O)R^{†}, —S(O)₂R^{†}, —S(O)₂NR^{†}₂, —C(S)NR^{†}₂, —C(NH)NR^{†}₂, or —N(R^{†})S(O)₂R^{†}; wherein each R^{†} is independently hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, or sulfur, or, notwithstanding the definition above, two independent occurrences of R^{†}, taken together with their intervening atom(s) form an unsubstituted 3-12-membered saturated, partially unsaturated, or aryl mono- or bicyclic ring having 0-4 heteroatoms independently selected from nitrogen, oxygen, or sulfur.

Suitable substituents on the aliphatic group of R^{†} are independently halogen, —R^{•}, -(haloR^{•}), —OH, —OR^{•}, —O(haloR^{•}), —CN, —C(O)OH, —C(O)OR^{•}, —NH₂, —NHR^{•}, —NR^{•}₂, or —NO₂, wherein each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

As used herein, the term “derivative” refers to a compound having a structure derived from the structure of a parent compound (e.g., a compound disclosed herein) and whose structure is sufficiently similar to those disclosed herein and based upon that similarity, would be expected by one skilled in the art to exhibit the same or similar activities and utilities as the claimed compounds, or to induce, as a precursor, the same or similar activities and utilities as the claimed compounds. Exemplary derivatives include salts, esters, amides, salts of esters or amides, and N-oxides of a parent compound.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

One aspect of the present invention relates to the solution to the problem of aggregation of sulfide phosphors when embedded into the polymer matrix. The polymer matrix which may be organic or inorganic may include a polymer selected from a group of thermoplastics. Examples may include, but are not limited to, the following materials such as polyethylene, polypropylene, polymethyl methacrylate, polystyrene, and polycarbonate. The objective of the present invention is to provide a method of surface coating of a disclosed sulfide phosphor with a silica and a method of functionalization of the silica-coated sulfide phosphor with a silane to make the phosphor surface compatible with the polymer matrix with minimal to no change in its luminescent properties. The sulfide phosphors may include sulfides for example calcium sulfide (CaS), strontium sulfide (SrS), cadmium sulfide (CdS), zinc sulfide (ZnS), copper sulfide (CuS) and any combination thereof. The sulfide phosphor may be doped with at least one rare earth ion selected from Eu, Tb, Ce, Dy, Sm, Yb and Er.

Reference to “a” chemical compound refers one or more molecules of the chemical compound, rather than being limited to a single molecule of the chemical compound. Further, the one or more molecules may or may not be identical, so long as they fall under the category of the chemical compound. Thus, for example, “a” polyamide is interpreted to include one or more polymer molecules of the polyamide, where the polymer molecules may or may not be identical (e.g., different molecular weights and/or isomers).

As used herein, the term “units” can be used to refer to individual (co)monomer units such that, for example, styrenic repeat units refers to individual styrene (co)monomer units in the polymer. In addition, the term “units” can be used to refer to polymeric block units such that, for example, “styrene repeating units” can also refer to polystyrene blocks; “units of polyethylene” refers to block units of polyethylene; “units of polypropylene” refers to block units of polypropylene; “units of polybutylene” refers to block units of polybutylene, and so on. Such use will be clear from the context.

The term “polymer” refers generally to a molecule which may be of high relative molecular mass/weight, the structure of which includes repeat units derived, actually or conceptually, from molecules of low relative molecular mass (monomers). The term “copolymer” refers to a polymer including two or more dissimilar repeat units (including terpolymers—comprising three dissimilar repeat units—etc.). The term “oligomer” refers generally to a molecule of intermediate relative molecular mass, the structure of which includes a small plurality of units derived, actually or conceptually, from molecules of lower relative molecular mass (monomers). In general, a polymer is a compound having >1, and more typically >10 repeat units or monomer units, while an oligomer is a compound having >1 and <20, and more typically less than ten repeat units or monomer units. As used herein, the term “nanoparticle” refers to a particle having a dimension in the range of 1 to 100 nanometers (nm).

In a number of representative embodiments hereof, the preparation of functional particles/nanoparticles (for example, with high thermal conductivity) is set forth. Functionalized particles hereof may, for example, include tethered groups (such as polymer/copolymer chains and/or relatively low molecular weight groups), which allow dispersion in targeted matrices. The tethered functionality may also enable direct reaction with, or dispersion in, matrix forming chemicals or precursors.

To provide, for example, controlled loading volumes/weights, incorporate specific physical properties and a desired structure within composite compositions hereof, systems, methods and compositions hereof may, for example, include a plurality of surface-coated phosphor particles dispersed within a matrix material. The surface functionalized and coated particles (i.e., surface-modified phosphors) are different from the surface-coated only particles in size or composition, or both size and composition and may, for example, be inorganic particles or organic particles.

Synthetic routes for the preparation of surface-modified (i.e., surface-functionalized and surface-coated) inorganic particles with enhanced activation of the surface are discussed herein. Such enhanced activation may provide for uniform dispersion of the surface-modified phosphor particles in a polymeric or other matrix. The synthetic procedures include, for example, direct synthesis of phosphors, preparation of surface-coated phosphors particles, and preparation of functionalized surface-coated phosphors. In each of these synthetic routes, uniform, dispersible surface-modified phosphor particles are formed for dispersion in and/or reaction with targeted matrices.

The surface-modified phosphors hereof may be incorporated within matrix materials (which may, for example, be a polymer matrix or unreacted precursors of a polymer matrix), to improve luminescent properties of the phosphor composition in a matrix. The procedures for surface modification of phosphors (for example, with surface coating and functionalization) assist in preventing phosphors from aggregation and achieve better dispersability in selected target matrices.

As used herein, “phosphors” and “phosphors” are used interchangeably.

In a number of embodiments hereof, method of preparing stable phosphors, for example, silica-coated phosphors, allows extended stability of these phosphors in a matrix. And further functionalization, for example, with a silane, allows uniform incorporation of the phosphors into the matrix, without changing luminescent properties of the phosphors. Achieving this improved stability and uniform dispersion in the matrix, for example, greenhouse film, would allow increase in photosynthesis, and thereby increased plant growth and development, which in turn improves the crop yield.

A. Phosphors

In various embodiments of the present invention, a suitable phosphor used in the disclosed methods is a silicate phosphor, an aluminate phosphor, a nitride phosphor, an oxynitride phosphor, a sulfide phosphor, or an oxysulfide phosphor.

In one embodiment of the present invention, the phosphor is selected from calcium sulfide, strontium sulfide, zinc sulfide, cadmium sulfide, copper sulfide, silver sulfide, barium sulfide, or combinations thereof. In another embodiment, a phosphor comprising a sulfide that can be doped with at least one rare earth ion, such as Eu, Tb, Ce, Dy, Sm, Yb and Er, Nd, Pr, Gd, Tm, or combinations thereof. In yet another embodiment, a phosphor comprising a sulfide that can be doped with non-rare earth ion, such as Mn, Ga, In, Al, Zn, Cu, or combinations thereof.

In a further embodiment, the phosphor is a calcium sulfide phosphor doped with Eu; a calcium sulfide phosphor doped with Eu and Mn; a zinc sulfide phosphor doped with Eu; a zinc sulfide phosphor doped with Eu and Mn; a strontium sulfide phosphor doped with Eu; a strontium sulfide phosphor doped with Eu and Mn; a cadmium sulfide phosphor doped with Eu and Mn; a cadmium sulfide phosphor doped with Zn; a cadmium sulfide phosphor doped with Zn and Cu; or combinations thereof.

In various embodiments, the phosphor is a sulfide phosphor, for example, (Ca, Sr)S:Eu, (Ca, Sr, Ba)(Al, In, Ga)₂S₄:Eu, CaS:Eu, (Zn, Cd)S:Eu:Ag. In other embodiments, the phosphor is a nitride phosphor: (Ca, Sr, Ba)₂Si₅N₈:Eu, CaAlSiN₃:Eu, Ce(Ca, Sr, Ba)Si₇N₁₀:Eu or (Ca, Sr, Ba)SiN₂:Eu. Other phosphors include Ba²⁺, Mg²⁺ co-doped Sr₂SiO₄, (Y, Gd, Lu, Sc, Sm, Tb, Th, Ir, Sb, Bi)₃(Al, Ga)₅O₁₂:Ce (with or without Pr), YSiO₂N:Ce, Y₂Si₃O₃N₄:Ce, Gd₂Si₃O₃N₄:Ce, (Y, Gd, Tb, Lu)₃Al₅₋ₓSiₓO₁₂₋ₓ:Ce, BaMgAl₁₀O₁₇:Eu (with or without Mn), SrAl₂O₄:Eu, Sr₄Al₄O₂₅:Eu, (Ca, Sr, Ba)Si₂N₂O₂:Eu, SrSi, Al₂O₃N₂:Eu, (Ca, Sr, Ba)Si₂N₂O₂:Eu, (Ca, Sr, Ba)SiN₂:Eu and (Ca, Sr, Ba)SiO₄:Eu. (See, for further details, WO 2020/028889; Winkler et al., U.S. Patent Application Publ. No. 2010/0283076; and Lee et al., Applied Surface Science 257, (2011) 8355-8369; each of them incorporated herein by reference.)

In other embodiments, the phosphor is an aluminum-silicate-based orange-red phosphor with mixed divalent and trivalent cations of formula (Sr_{1-x-y}MₓT_{y})₃₋ₘEuₘ(Si₁₋ₓAl_{z})O₅ where M is at least one of Ba, Mg and Zn, T is a trivalent metal, 0≤x≤0.4, 0≤y≤0.4, 0≤z≤0.2 and 0.001≤m≤0.4. (See, for further details of these phosphors, WO 2020/028889; Liu et al., U.S. Patent Application Publ. No. 2008/0111472, both incorporated herein by reference.)

In one embodiment, the phosphor is a YAG:Ce phosphor of formula (Y,A)₃(Al,B)₅(O,C)₁₂:Ce³⁺ where A is selected from the group consisting of Tb, Gd, Sm, La, Sr, Ba, Ca, and where A substitutes for Y in amounts ranging from about 0.1 to 100 percent; B is selected from the group consisting of Si, Ge, B, P and Ga, and where B substitutes for Al in amounts ranging from about 0.1 to 100 percent; and, C is selected from the group consisting of F, Cl, N and S and where C substitutes for O in amounts ranging from about 0.1 to 100 percent. (See, for further details of these phosphors, WO 2020/028889; Tao et al., U.S. Patent Application Publ. No. 2008/0138268; both incorporated herein by reference.)

In a further embodiment, the phosphor is a silicate-based yellow-green phosphor of formula A₂SiO₄:Eu²⁺D where A is Sr, Ca, Ba, Mg, Zn and Cd; and D is a dopant selected from the group consisting of F, Cl, Br, I, P, S and N. (See, for further details of these phosphors, WO 2020/028889; Wang et al., U.S. Pat. No. 7,311,858, both incorporated herein by reference.)

In another embodiment, the phosphor is an aluminate-based blue phosphor of formula (M₁₋ₓEuₓ)_{2-z}MgAl_{y})O_{(2+3/2)y} where M is at least one of Ba and Sr, (0.05<x<0.5; 3≤y≤8; and 0.8≤z≤1<1.2) or (0.2<x<0.5; 3≤y≤8; and 0.8≤z≤1<1.2) or (0.05<x<0.5; 3≤y≤12; and 0.8≤z≤1<1.2) or (0.2<x<0.5; 3≤y≤12; and 0.8≤z≤1<1.2) or (0.05<x<0.5; 3≤y≤6; and 0.8≤z≤1.2). (See, for further details of these phosphors, WO 2020/028889; Dong et al., U.S. Pat. No. 7,390,437; both incorporated herein by reference.)

In yet another embodiment, the phosphor is a yellow phosphor of formula (Gd₁₋ₓAₓ)(V_{1-y}B_{y})(O_{4-z}C_{z}) where A is Bi, TI, Y, La, Ce, Pr, Nd, Pm, Sm, Eu, Tb, Dy, Ho, Er, Tm, Yb, Lu; B is Ta, Nb, W, and Mo; C is N, F, Br and I; 0<x<0.2; 0<y<0.1; and 0<z<0.1. (See, for further details of these phosphors, WO 2020/028889; Li et al., U.S. Pat. No. 7,399,428; both incorporated herein by reference.)

In a further embodiment, the phosphor is a yellow phosphor of formula A[Srₓ(M₁)₁₋ₓ]_{z}SiO₄·(1−a)[Sr_{y}(M₂)_{1-y}]ᵤSiO₅:Eu²⁺D where M₁ and M₂ are at least one of a divalent metal such as Ba, Mg, Ca, and Zn; 0.6≤a≤0.85; 0.3≤x≤0.6; 0.8≤y≤1; 1.5≤z≤2.5; and 2.6≤u≤3.3 and Eu and D are between 0.0001 and about 0.5; D is an anion selected form the group consisting of F, Cl, Br, S and N and at least some of D replaces oxygen in the host lattice. (See, for further details of these phosphors, WO 2020/028889; Li et al., U.S. Pat. No. 7,922,937; both incorporated herein by reference.)

In a still further embodiment, the phosphor is a silicate-based green phosphor of formula (Sr,A₁)ₓ(Si,A₂)(O,A₃)₂₊ₓ:Eu²⁺ where A₁ is at least one divalent metal ion such as Mg, Ca, Ba, Zn or a combination of +1 and =3 ions; A₂ is a 3+, 4+ or 5+ cation including at least one of B, Al, Ga, C, Ge, P; A₃ is a 1−, 2− or 3− anion including F, Cl, and Br; and 1.5≤x≤2.5. (See, for further details of these phosphors, WO 2020/028889; Li et al., U.S. Patent Application Publ. No. 2009/0294731; both incorporated by reference herein.)

In one embodiment, the phosphor is a nitride-based red phosphor of formula MₐM_{b}B_{c}(N,D):Eu²⁺ where Mₐ is a divalent metal ion such as Mg, Ca, Sr, Ba; M_{b} is trivalent metal such as Al, Ga, Bi, Y, La, Sm; M_{c} is a tetravalent element such as Si, Ge, P1, and B; N is nitrogen; and D is a halogen such as F, Cl, or Br. (See, for further details of these phosphors, WO 2020/028889; Liu et al., U.S. Patent Application Publ. No. 2009/0283721; both incorporated herein by reference.)

In another embodiment, the phosphor is a silicate-based orange phosphor of formula (Sr,A₁)ₓ(Si,A₂)(O,A₃)₂₊ₓ:Eu²⁺ where A₁ is at least one divalent metal ion such as Mg, Ca, Ba, Zn or a combination of +1 and =3 ions; A₂ is a 3+, 4+ or 5+ cation including at least one of B, Al, Ga, C, Ge, P; A₃ is a 1−, 2− or 3− anion including F, Cl, and Br; and 1.5×2.5. (See, for further details of these phosphors, WO 2020/028889; Cheng et al., U.S. Pat. No. 7,655,156; both incorporated by reference herein.)

In yet another embodiment, the phosphor is a aluminate-based green phosphor of formula M₁₋ₓEuₓMg_{1-y}Mn_{y}Al_{z}O_{[(x+y)+3z/2)} where 0.1<x<1.0; 0.1<y<1.0; 0.2<x+y<2.0; and 2≤z≤14. (See, for further details of these phosphors, WO 2020/028889; Wang et al., U.S. Pat. No. 7,755,276; both incorporated by reference herein.)

In a further embodiment, the phosphors include a rare earth halide as a raw material source of not only the rare earth activator for the phosphor but also the halogen itself. While not wishing to be bound by any particular theory or mechanism of action, it is believed that the halogen may play a dual role in enhancing the properties of these phosphors by (i) reducing the oxygen content and (ii) causing an increase in photoluminescence intensity. Further, the silica coating provides an increase in the stability of the phosphors.

1. Method of Preparing a Phosphor

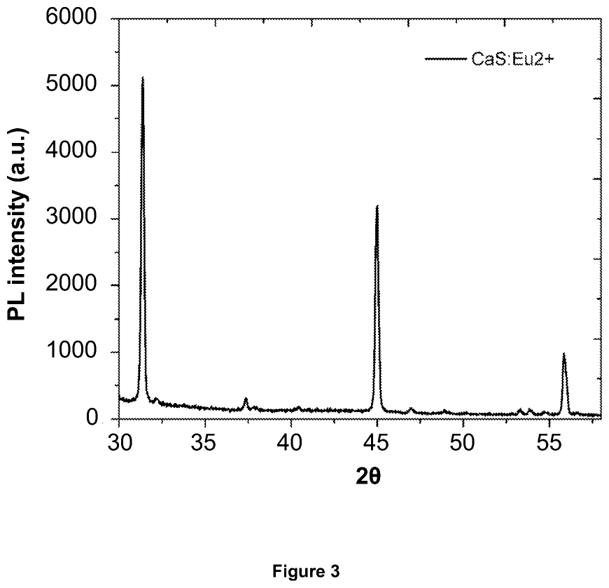

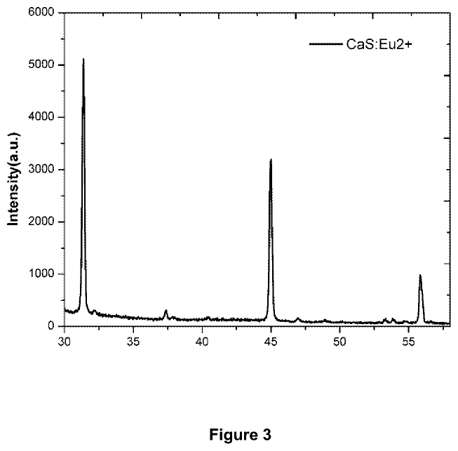

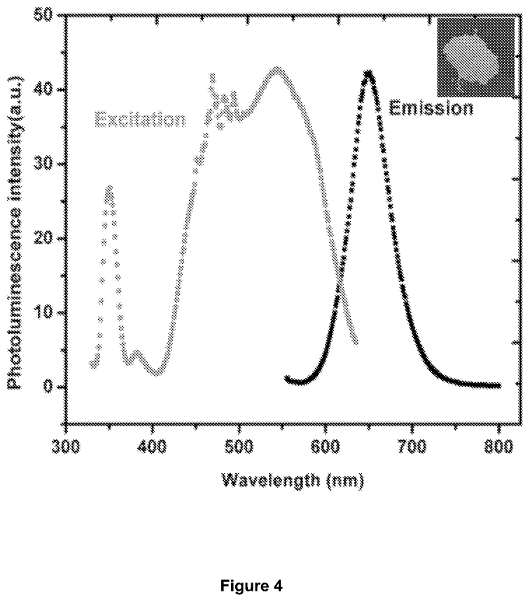

In one embodiment, the present invention relates to methods for synthesizing a CaS:Eu²⁺ phosphor, a red emitting phosphor, that can be used in a number of light converting articles, e.g., greenhouse film. As described in Example 1, a method of CaS:Eu²⁺ phosphor synthesis comprises: (i) preparing a phosphor reaction mixture comprising a salt material, a sulfur compound, a rare earth element, a surfactant, and a solvent; (ii) heating the phosphor reaction mixture; (iii) isolating the phosphor particles from the phosphor reaction mixture; (iv) drying the phosphor particles; and (v) firing the dried phosphor particles. FIG. 3 shows X-ray diffraction pattern of CaS:Eu²⁺ phosphor particles. And FIG. 4 shows photoluminescence emission and excitation of CaS:Eu²⁺ phosphor. Inset in FIG. 4 shows that CaS:Eu²⁺ phosphor is red light emitting under UV light.

In another embodiment, the salt material can be calcium salts, strontium salts, cadmium salts, zinc salts, copper salts, manganese salts, terbium salts, and combinations thereof. In yet another embodiment, the rare earth element can be Eu, Tb, Ce, Dy, Sm, Yb, Er, and combinations thereof. In a further embodiment, the sulfur compound comprises an organosulfide. In still a further embodiment, the sulfur compound comprises thiols, elemental sulfur, thioesters, sulfur halide, and combinations thereof. In even further embodiment, the sulfur compound comprises thiourea, diisopropyle-2-thiourea, 1,3-di-tolyl-2-thiourea, 1-(2-methoxyphenyl)-2-thiourea, propylene thiourea, sulfonamide, sulfur powder, thioacetamide, and the like.

In a still further embodiment, the surfactant can be cetyltrimethylammonium bromide, polyoxyethylene (5) nonylphenylether (IGEPAL® CO-520), IGEPAL® CA-630, Triton X-100, Tween, polybenzene compounds, polyoxyethylene alkyl ethers, polyglycerol alkyl ethers, lauryl glucoside, decyl glucoside, n-dodecyl-b-D-maltoside, Zonyl FSO, lauric acid, oleic acid, digitonin, poloxamer, lauramide monoethylamine, aluramide diethylamine, Nonoxynol 9, glycerol monolayrate, pentapropylene glycol monododecyl ether, octapropylene glycol monododecyl ether, pentaethylene glycol monododecyl ether, octaethylene glycol monododecyl ether, oleylamine, cetyltrimethylarmmonium chloride (CTAC), Dimethyldioctadecylammonium chloride, or combinations thereof.

In a further embodiment, the solvent can be an organic solvent, for example, dimethyl sulfoxide, methyl sulfoxide, dimethyl formamide, toluene, alcohol, esters, ethers, amines, 1,2-dimethoxy-ethane, 1,4-dioxane, Tetrahydro furan, ethyl acetate, and the like.

In various embodiments, the phosphor reaction mixture comprising a salt material, a sulfur compound, a rare earth element, a surfactant, and a solvent can be dissolved using magnetic stirring, ultrasonication bath, and the like, and heated at about 50° C. to about 200° C. for about 1 hour to about 20 hours. In one embodiment, the heating comprises heating the reaction mixture at about 80° C. to about 150° C. for about 1 hour to about 10 hours. In another embodiment, the heating comprises heating the reaction mixture at about 90° C. to about 140° C. for about 5 hour to about 10 hours.

In various embodiments, the method of preparing a phosphor can further comprise removing a liquid phase from the phosphor particles, e.g., by centrifugation, filtration, decantation, or other methods known to the skilled artisan. Following removal of the liquid phase, the phosphor can be washed with acetone, ethanol, methanol, or the combinations thereof, and dried.

In one embodiment, drying comprises heating the dried phosphor particles at 20° C. to about 100° C. for a period of time of about 10 minutes to about 48 hours. In another embodiment, drying comprises heating the phosphor particles 40° C. to about 80° C. for a period of time of about 30 minutes to about 48 hours. In yet another embodiment, drying comprises heating the phosphor particles 50° C. to about 80° C. for a period of time of about 30 minutes to about 24 hours.

In one embodiment, the phosphor particles can be dried at ambient pressure. In another embodiment, the phosphor particles can be dried in a vacuum furnace.

In a further embodiment, the dried phosphor particles can further undergo micronizing, grinding, or combinations thereof to provide a surface-modified phosphor with a desired particle size, e.g., about 1 nm to about 1000 nm. In a still further embodiment, the dried phosphor particles can further undergo micronizing, grinding, or combinations thereof to provide a surface-modified phosphor with a particle size of about 2 nm to about 600 nm.

In another embodiment, the dried phosphor particles can further undergo micronizing, grinding, or combinations thereof to provide a phosphor with a particle size of about 6 nm to about 400 nm.

In another embodiment the dried and ground particles can further be fried at 100° C. to about 1000° C. for about 1 hour to about 24 hours. In yet another embodiment the dried and ground particles can further be fried at 200° C. to about 1000° C. for about 1 hour to about 24 hours. In a further embodiment the dried and ground particles can further be fried at 400° C. to about 1000° C. for about 1 hour to about 24 hours. In another embodiment the dried and ground particles can further be fried at 300° C. to about 1000° C. for about 1 hour to about 24 hours.

In another embodiment, the phosphor particles can be fired at reducing atmosphere. In yet another embodiment, the phosphor particles can be dried at ambient pressure. In a further embodiment, the phosphor particles can be dried in a vacuum furnace.

B. Surface-Modified Phosphor

The present invention relates to new compositions of a surface-modified phosphor, providing unexpected benefits of increased stability and uniform dispersion in a polymer matrix and improved crop yield.

The present invention also relates to methods for surface-modification of a phosphor by providing two coating layers on the surface of a phosphor—(i) silica coating and (ii) silane coating (i.e., silane functionalization).

In one embodiment, the surface-modified phosphor comprises: CaS:Eu²⁺ phosphor, surface coating with a silica, and further functionalization with a silane. The surface-modified phosphor comprising a CaS:Eu²⁺ phosphor, silica coating, and silane functionalization can be prepared by the methods of preparing as disclosed herein below. For example, CaS:Eu²⁺ is synthesized as described below shown in Example 1. Silica coating on the CaS:Eu²⁺ phosphor allows extended stability by preventing oxidation of Eu²⁺, and allows further functionalization before dispersion in a matrix, such as a polymer matrix.

The silica coating on the phosphor is performed using reverse micelle method to prevent oxidation of Eu(II) doped phosphors to Eu(III) compounds, and thereby to protect the luminescence properties of the CaS:Eu(II) phosphors. Furthermore, silica acts as the most effective substrate for silane coating. The presence of silica on the surface of sulfide phosphor provides the necessary hydroxyl groups for silanization, thereby improving the silane coating on the phosphors surface.

The silica used for surface coating of a sulfide phosphor can be an inorganic silica, organic silica, or a hybrid of inorganic-organic silica, such as, but not limited to, silicon dioxide, alkyl silicates, methyl silicates, ethyl silicates, orthosilicates, alkyl orthosilicates, diethylsilicate, methyl orthosilicate, ethyl orthosilicate, tetraethyl orthosilica (TEOS), diethyl dimethyl orthosilicate, diethyl bis(trimethylsilyl) orthosilicate, tetramethyl orthosilicate, sodium silicate, potassium silicate, and the like.

Further, the silane functionalization of the silica-coated phosphor is performed in an alcoholic solution to improve the stability of the silica-coated phosphor. And the silane functionalization is performed in an acidic environment to accelerate the hydrolysis of the silane functional agent. The silane functionalization of the silica-coated phosphor allows for uniform and better dispersion of the surface-modified phosphors into the matrix, such as a greenhouse film, since silanes can improve the compatibility of inorganic materials with organic materials.

The silane used for functionalization of a silica-coated sulfide phosphor can be an organosilane, but not limited to, such as, alkyl silanes, methyl silane, alkoxysilanes, 3-methacryloxypropyltrimethoxysilane, vinyltrimethoxysilane, (3-mercaptopropyl)trimethoxysilane, 3-(methacryloyloxy)propyldimethylethoxysilane, 3-(methacryloyloxy)propenyltrimethoxysilane, 3-(methacryloyloxy)propyltrimethoxysilane, and the like. Preferably the silane functional agent may include long chain hydrocarbons.

In one embodiment, the phosphors have an average particle size of about 1 nm to about 3000 nm. In another embodiment, the phosphors have an average particle size of about 1 nm to about 1000 nm. In a further embodiment, the phosphors have an average particle size of about 1 nm to about 500 nm. In a still further embodiment, the phosphors have an average particle size of about 1 nm to about 300 nm. In a yet further embodiment, the phosphors have an average particle size of about 2 nm to about 300 nm. In an even further embodiment, the phosphors have an average particle size of about 5 nm to about 300 nm.

In the surface-coated phosphor, a phosphor is attached to a silica. As defined herein above, “attached” can refer to covalent or non-covalent interaction between two or more molecules. Non-covalent interactions can include ionic bonds, electrostatic interactions, van der Walls forces, dipole-dipole interactions, dipole-induced-dipole interactions, London dispersion forces, hydrogen bonding, halogen bonding, electromagnetic interactions, π-π interactions, cation-r interactions, anion-r interactions, polar r-interactions, and hydrophobic effects.

In the surface-modified phosphor, a silica-coated phosphor is attached to a silane. As defined herein above, “attached” can refer to covalent or non-covalent interaction between two or more molecules. Non-covalent interactions can include ionic bonds, electrostatic interactions, van der Walls forces, dipole-dipole interactions, dipole-induced-dipole interactions, London dispersion forces, hydrogen bonding, halogen bonding, electromagnetic interactions, π-π interactions, cation-r interactions, anion-r interactions, polar r-interactions, and hydrophobic effects.

In one embodiment, the surface-coated phosphors comprise a silica and a phosphor such that weight ratio of silica to phosphor, based on the total weight of the surface-coated phosphor material, that is from about 0.0001:1 to about 5:3. In another embodiment, the surface-coated phosphors comprise a silica and a phosphor such that weight ratio of silica to phosphor, based on the total weight of the surface-coated phosphor, that is from about 0.0001:2 to about 2:1. In yet another embodiment, the surface-coated phosphors comprise a silica and a phosphor such that weight ratio of silica to phosphor, based on the total weight of the surface-coated phosphor, that is from about 1:2 to about 2:1. In a further embodiment, the surface-coated phosphors comprise a silica and a phosphor such that weight ratio of silica to phosphor, based on the total weight of the surface-coated phosphor, that is about 1:1.

In one embodiment, the surface-coated phosphors comprise a silica and a phosphor such that weight ratio of silica to phosphor, based on the total weight of the surface-coated phosphor, of about 0.0001:1, about 0.0001:2, about 0.0001:3, about 0.0001:4, about 0.0001:5, about 0.001:1, about 0.001:2, about 0.001:3, about 0.001:4, about 0.001:5, about 0.01:1, about 0.01:2, about 0.01:3; about 0.01:4, about 0.1:5, about 0.1:1, about 0.1:2, about 0.1:3, about 0.1:4, about 0.1:5, about 1:6, about 1:5, about 1:4, about 1:3, about 1:2, about 1:1, about 2:1, about 3:2, about 3:1, about 4:3, about 4:2, about 4:1, about 5:3; or any weight range within the foregoing weight ratio values; or any combination of the foregoing weight ratios.

In another embodiment, the surface-modified phosphors comprise a wt % of silica, based on the total weight of the surface-modified phosphor, which is from about 0.01 wt % to about 90 wt %. In yet another embodiment, the surface-modified phosphors comprise a wt % of silica, based on the total weight of the surface-modified phosphor, which is from about 10 wt % to about 70 wt %. In a further embodiment, the surface-modified phosphors comprise a wt % of silica, based on the total weight of the surface-modified phosphor, which is from about 40 wt % to about 60 wt %. In a still further embodiment, the surface-modified phosphors comprise a wt % of silica, based on the total weight of the surface-modified phosphor, which is from about 45 wt % to about 65 wt %, or any weight range within the foregoing weight ratio values; or any combination of the foregoing weight ratios.

In one embodiment, the surface-modified phosphors comprise a silane and a silica-coated phosphor such that weight ratio of silane to silica-coated phosphor, based on the total weight of the surface-modified phosphor, that is from about 0.0001:1 to about 5:3. In another embodiment, the surface-modified phosphors comprise a silane and a silica-coated phosphor such that weight ratio of silane to silica-coated phosphor, based on the total weight of the surface-modified phosphor, that is from about 0.0001:2 to about 2:1. In yet another embodiment, the surface-modified phosphors comprise a silane and a silica-coated phosphor such that weight ratio of silane to silica-coated phosphor, based on the total weight of the surface-modified phosphor, that is from about 1:2 to about 2:1. In a further embodiment, the surface-modified phosphors comprise a silane and a silica-coated phosphor such that weight ratio of silane to silica-coated phosphor, based on the total weight of the surface-modified phosphor, that is about 1:1.

In one embodiment, the surface-modified phosphors comprise a silane and a silica-coated phosphor such that weight ratio of silane to silica-coated phosphor, based on the total weight of the surface-modified phosphor, of about 0.0001:1, about 0.0001:2, about 0.0001:3, about 0.0001:4, about 0.0001:5, about 0.001:1, about 0.001:2, about 0.001:3, about 0.001:4, about 0.001:5, about 0.01:1, about 0.01:2, about 0.01:3; about 0.01:4, about 0.1:5, about 0.1:1, about 0.1:2, about 0.1:3, about 0.1:4, about 0.1:5, about 1:6, about 1:5, about 1:4, about 1:3, about 1:2, about 1:1, about 2:1, about 3:2, about 3:1, about 4:3, about 4:2, about 4:1, about 5:3; or any weight range within the foregoing weight ratio values; or any combination of the foregoing weight ratios.

In another embodiment, the surface-modified phosphors comprise a wt % of silane, based on the total weight of the surface-modified phosphor, which is from about 0.01 wt % to about 90 wt %. In yet another embodiment, the surface-modified phosphors comprise a wt % of silane, based on the total weight of the surface-modified phosphor, which is from about 10 wt % to about 70 wt %. In even yet another embodiment, the surface-modified phosphors comprise a wt % of silane, based on the total weight of the surface-modified phosphor, which is from about 40 wt % to about 60 wt %. In a further embodiment, the surface-modified phosphors comprise a wt % of silane, based on the total weight of the surface-modified phosphor, which is from about 45 wt % to about 65 wt %, or any weight range within the foregoing weight ratio values; or any combination of the foregoing weight ratios.

In a further embodiment, the surface-modified phosphors comprise a wt % of phosphor, based on the total weight of the surface-modified phosphor, which is from about 30 wt % to about 90 wt %. In a still further embodiment, the surface-modified phosphors comprise a wt % of silica-coated phosphor, based on the total weight of the surface-modified phosphor, which is from about 40 wt % to about 60 wt %. In a further embodiment, the surface-modified phosphors comprise a wt % of silica-coated phosphor, based on the total weight of the surface-modified phosphor, which is from about 45 wt % to about 55 wt %.

In one embodiment, the surface-modified phosphors have an average particle size of about 1 nm to about 5500 nm. In another embodiment, the surface-modified phosphors have an average particle size of about 2 nm to about 5000 nm. In a further embodiment, the surface-modified phosphors have an average particle size of about 2 nm to about 21 nm. In a still further embodiment, the surface-modified phosphors have an average particle size of about 2 nm to about 11 nm. In a yet further embodiment, the surface-modified phosphors have an average particle size within the foregoing size values; or any combination of the foregoing size values.

In one embodiment, the surface-modified phosphors have a phosphor core surrounded by a surface-modified surface as a coating comprising (i) a silica coating layer and (ii) a silane functionalization layer. In another embodiment, the coating surrounding the phosphor core has a coating thickness of about 1 nm to about 500 nm. In a further embodiment, the coating surrounding the phosphor core has a coating thickness of about 1 nm to about 300 nm. In a still further embodiment, the coating surrounding the phosphor core has a coating thickness of about 1 nm to about 100 nm. In a yet further embodiment, the surface-modified phosphors have an average particle size within the foregoing size values; or any combination of the foregoing size values.

In one embodiment, the surface-coated phosphors have a phosphor core surrounded by a silica coating layer. In another embodiment, the silica coating surrounding the phosphor core has a coating layer thickness of about 0.01 nm to about 200 nm. In a further embodiment, the silica coating layer surrounding the phosphor core has a coating layer thickness of about 1 nm to about 100 nm. In a still further embodiment, the silica coating surrounding the phosphor core has a coating layer thickness of about 1 nm to about 50 nm. In a yet further embodiment, the surface-modified phosphors have an average particle size within the foregoing size values; or any combination of the foregoing size values.

In one embodiment, the surface-modified phosphors have a silica-coated phosphor core surrounded by a silane functionalization layer. In another embodiment, the silane functionalization coating surrounding the silica-coated phosphor core has a coating layer thickness of about 0.1 nm to about 300 nm. In a further embodiment, the silane functionalization coating surrounding the silica-coated phosphor core has a coating thickness of about 1 nm to about 100 nm. In a still further embodiment, the silane functionalization coating surrounding the phosphor core has a coating thickness of about 1 nm to about 50 nm. In a yet further embodiment, the surface-modified phosphors have an average particle size within the foregoing size values; or any combination of the foregoing size values.

In one embodiment, the photoluminescence of the surface-modified phosphors is about 1% to about 100% the photoluminescence of the same phosphors that are not surface-modified. In another embodiment, the photoluminescence of the surface-modified phosphors is about 10% to about 90% the photoluminescence of the same phosphors that are not surface-modified. In a further embodiment, the photoluminescence of the surface-modified phosphors is about 70% to about 100% the photoluminescence of the same phosphors that are not surface-modified. In a still further embodiment, the photoluminescence of the surface-modified phosphors is about 80% to about 100% the photoluminescence of the same phosphors that are not surface-modified. In a yet further embodiment, the photoluminescence of the surface-modified phosphors is about 90% to about 100% the photoluminescence of the same phosphors that are not surface-modified.

C. Method of Preparing a Surface-Modified Phosphor

1. Method of Preparing a Silica-Coated Phosphor

In one embodiment, the present invention relates to methods for providing a surface coating to phosphors wherein the surface coating comprises silica ligands attached to a phosphor and/or to one another forming a coating. The surface coating with silica increases the compatibility of the phosphor surface for further functionalization with silane ligands and increases the stability of the phosphor, without changing its luminescent properties.

The silica coating on the phosphor is performed using reverse micelle method to prevent oxidation of Eu(II) doped phosphors to Eu(III) compounds, and thereby to protect the luminescence properties of the CaS:Eu(II) phosphors. Furthermore, silica acts as the most effective substrate for silane coating. The presence of silica on the surface of sulfide phosphor provides the necessary hydroxyl groups for silanization and improves the silane coating on the phosphors surface.

In one embodiment, the present invention relates to methods for preparing a surface-coated phosphor materials, the method comprising: preparing a micelle with a surfactant and an alkane; preparing phosphor mixture comprising a phosphor and a micelle with a surfactant and an alkane; preparing a surface-coating solution comprising a silicate, ammonia, and water; preparing a surface-coating phosphor reaction mixture by mixing the phosphor mixture and the surface-coating solution; stirring the surface-coating phosphor reaction mixture at room temperature; and thereby forming the surface-coated (i.e., silica-coated) phosphor material.

In one embodiment, the surfactant is a non-ionic surfactant, for example, Polyoxyethylene (5) nonylphenylether (IGEPAL® CO-520), IGEPAL® CA-630, Triton X-100, Tween, polybenzene compounds, polyoxyethylene alkyl ethers, polyglycerol alkyl ethers, lauryl glucoside, decyl glucoside, n-dodecyl-b-D-maltoside, Zonyl FSO, lauric acid, oleic acid, digitonin, poloxamer, lauramide monoethylamine, aluramide diethylamine, Nonoxynol 9, glycerol monolayrate, pentapropylene glycol monododecyl ether, octapropylene glycol monododecyl ether, pentaethylene glycol monododecyl ether, octaethylene glycol monododecyl ether, or combinations thereof. (See, for further details, Rapp, Microfluids: Modeling, Mechanics and Mathematics, ISBN 9781455731510, 2016.)

In another embodiment, the alkane is a cycloalkane, such as cyclohexane, cyclopropane, cyclobutane, cyclopentane, cycloheptane, cyclooctane, cyclononane, cyclodecane, and the like. In yet another embodiment, the alkane can be a linear alkane or branched alkane, e.g., hexane, octane, pentane, toluene, benzene, chloroform, diethyl ether, dichloromethane, and the like.

The silica used for surface coating of a sulfide phosphor can be an inorganic silica, organic silica, or hybrid of inorganic-organic silica, such as, but not limited to, silicon dioxide, potassium silicate, sodium silicate, alkyl silicates, methyl silicates, ethyl silicates, orthosilicates, alkyl orthosilicates, diethylsilicate, methyl orthosilicate, ethyl orthosilicate, tetraethyl orthosilica (TEOS), tetramethyl orthosilicate, tetrapropyl orthosilicate, diethyl dimethyl orthosilicate, diethyl bis(trimethylsilyl) orthosilicate, and the like.

2. Method of Preparing a Silica-Coated and Silane-Functionalized Phosphor

In one embodiment, the present invention relates to methods for providing a surface modification by functionalization of silica-coated phosphors, as described herein, comprising silane ligands attached to the silica-coated phosphor. The silane functionalization of silica-coated phosphors increases the stability of the phosphor and improves uniform dispersion in a polymer matrix, without changing its luminescent properties.

In another embodiment, the present invention relates to a method of preparing a surface-modified phosphor material, the method comprising: preparing a surface-coated mixture comprising a surface-coated phosphor and an alcohol; preparing a functionalization solution comprising a silane functional agent and acidic water; preparing a functionalization surface-coated phosphor reaction mixture by mixing the surface-coated phosphor mixture and the functionalization solution; isolating the functionalized surface-coated phosphor particles; drying the isolated functionalized surface-coated phosphor particles; and thereby forming the surface-modified (i.e., silica-coated and silane-functionalized) phosphor.

In a further embodiment, the present invention relates to a method of preparing a surface-modified phosphor material, the method comprising: preparing a surface-coated mixture comprising a surface-coated phosphor and an alcohol; preparing a functionalization solution comprising a silane functional agent and acidic water; preparing a functionalization surface-coated phosphor reaction mixture by mixing the surface-coated phosphor mixture and the functionalization solution; isolating the functionalized surface-coated phosphor particles; drying the isolated functionalized surface-coated phosphor particles in an inert atmosphere; and thereby forming the surface-modified (i.e., silica-coated and silane-functionalized) phosphor.

In a further embodiment, the present invention relates to a method of preparing a surface-modified phosphor, the method comprising: preparing a surface-coated mixture comprising a surface-coated phosphor and an alcohol; preparing a functionalization solution comprising a silane functional agent and acidic water, wherein the functionalization solution has a pH of about 1 to about 6; preparing a functionalization surface-coated phosphor reaction mixture by mixing the surface-coated phosphor mixture and the functionalization solution; isolating the functionalized surface-coated phosphor particles; drying the isolated functionalized surface-coated phosphor particles in an inert atmosphere; and thereby forming the surface-modified (i.e., silica-coated and silane-functionalized) phosphor.

In a further embodiment, the present invention relates to a method of preparing a surface-modified phosphor, the method comprising: preparing a surface-coated mixture comprising a surface-coated phosphor and an alcohol; preparing a functionalization solution comprising a silane functional agent and acidic water, wherein the functionalization solution has a pH of about 1 to about 6; preparing a functionalization surface-coated phosphor reaction mixture by mixing the surface-coated phosphor mixture and the functionalization solution; isolating the functionalized surface-coated phosphor particles; drying the isolated functionalized surface-coated phosphor particles in an inert atmosphere; and thereby forming the surface-modified (i.e., silica-coated and silane-functionalized) phosphor.

In another embodiment, the functionalization solution has a pH of about 2 to about 6. In yet another embodiment, the functionalization solution has a pH of about 2 to about 5. In a still further embodiment, the functionalization solution has a pH of about 3 to about 5. The pH of the water in the functionalization solution can be adjusted to an appropriate pH after mixing water and the silane material, e.g., by using HCl, sulfuric acid, acetic acid, phosphoric acid, nitric acid, or combinations thereof.

In a further embodiment, the alcohol can be any convenient alcohol, e.g., a short chain alkyl alcohol such as a C₁-C₁₀ alkyl alcohol, for example methanol, ethanol, propanol, isopropanol, and mixtures thereof.

In another embodiment, the method can be carried out under an inert atmosphere, e.g., nitrogen, argon, and combinations thereof.

In various embodiments, the surface-coating phosphor mixture comprises a surface-coated phosphor at a concentration of about 1 mg/ml to about 50 mg/ml. In another embodiment, the surface-coating phosphor mixture comprises a surface-coated phosphor at a concentration of about 1 mg/ml to about 20 mg/ml. In yet another embodiment, the surface-coating phosphor mixture comprises a surface-coated phosphor at a concentration of about 1 mg/ml to about 10 mg/ml. In a further embodiment, the surface-coating phosphor mixture comprises a surface-coated phosphor at a concentration of about 2.5 mg/ml to about 7.5 mg/ml. In a still further embodiment, the surface-coating phosphor comprises a surface-coated phosphor at a concentration of about 3.0 mg/ml to about 6.0 mg/ml.

In a further embodiment, the functionalization solution comprising a silane and acidic water comprises the silane at a concentration (v/v), based on the total volume of the surface-functionalization solution, of about 0.0025 to about 2.5. In a still further embodiment, the silane concentration (v/v), based on the total volume of the functionalization solution, is about 0.005 to about 0.25. In a yet further embodiment, silane concentration (v/v), based on the total volume of the functionalization solution, is about 0.025 to about 0.15. In an even further embodiment, the silane concentration (v/v), based on the total volume of the functionalization solution, is about 0.050 to about 0.125.

In another embodiment, the functionalization surface-coated phosphor reaction mixture comprises the silane at a v/v concentration, based on the total volume of the functionalization surface-coated phosphor reaction mixture, of about 0.0005 to about 0.5. In yet another embodiment, the silane concentration (v/v), based on the total volume of the functionalization surface-coated phosphor reaction mixture, is about 0.001 to about 0.05. In a further embodiment, the silane concentration (v/v), based on the total volume of the functionalization surface-coated phosphor reaction mixture, is about 0.005 to about 0.03. In a still further embodiment, the silane concentration (v/v), based on the total volume of the functionalization surface-coated phosphor reaction mixture, is about 0.010 to about 0.025.

In various embodiments, the silane may form a coating surrounding the silica-coated phosphor material. In some embodiments, the silane can form covalent linkages within the silane and/or attach to the silica-coated phosphor.

The silane functional agent used in the disclosed methods for functionalization of a silica-coated coating sulfide phosphor can be an organosilane, but not limited to, for example alkyl silanes, methyl silane, alkoxysilanes, 3-methacryloxypropyltrimethoxysilane, vinyltrimethoxysilane, (3-mercaptopropyl)trimethoxysilane, (3-trimethoxysilyl)propyl methacrylate, 3-(methacryloyloxy)propyldimethylethoxysilane, 3-(methacryloyloxy)propenyltrimethoxysilane, 3-(methacryloyloxy)propyltrimethoxysilane, or combinations thereof. Preferably the silane may include long chain hydrocarbons. In a further aspect, the silane is (3-mercaptopropyl)trimethoxysilane and (3-trimethoxysilyl)propyl methacrylate, or combinations thereof. (See, for further details, WO 2020/028889, which is incorporated herein by reference.)

In various embodiments, the method of preparing a surface-modified phosphor can further comprise removing a liquid phase from the surface-modified phosphor, e.g., by centrifugation, filtration, decantation, or other methods known to the skilled artisan. Following removal of the liquid phase, the surface-modified phosphor can be dried.

In one embodiment, the surface-modified phosphor particles can be dried at a temperature of about 40° C. to about 120° C. at ambient pressure. In another embodiment, the surface-modified phosphor particles can be dried at a temperature of about 50° C. to about 100° C. at ambient pressure. In yet another embodiment, the surface-modified phosphor particles can be dried at a temperature of about 50° C. to about 90° C. at ambient pressure. In a further embodiment, the surface-modified phosphor particles can be dried at a temperature of about 60° C. to about 90° C. at ambient pressure. In a still further embodiment, the surface-modified phosphor particles can be dried at a temperature of about 70° C. to about 85° C. at ambient pressure.

In one embodiment, drying comprises heating the isolated functionalized surface-coated phosphor particles for a period of time of about 10 minutes to about 48 hours. In another embodiment, drying comprises heating the isolated functionalized surface-coated phosphor particles for a period of time of about 30 minutes to about 48 hours. In yet another embodiment, drying comprises heating the isolated functionalized surface-coated phosphor particles for a period of time of about 30 minutes to about 24 hours. In a further embodiment, drying comprises heating the isolated functionalized surface-coated phosphor particles for a period of time of about 30 minutes to about 20 hours.

In one embodiment, the surface-modified phosphor particles can be dried at ambient pressure. In another embodiment, the surface-modified phosphor particles can be dried in a vacuum furnace.

In a further embodiment, the dried surface-modified phosphor particles can further undergo micronizing, grinding, or combinations thereof to provide a surface-modified phosphor with a desired particle size, e.g., about 1 nm to about 1000 nm. In a still further embodiment, the dried surface-modified phosphor particles can further undergo micronizing, grinding, or combinations thereof to provide a surface-modified phosphor with a particle size of about 2 nm to about 600 nm. In another embodiment, the dried surface-modified phosphor particles can further undergo micronizing, grinding, or combinations thereof to provide a surface-modified phosphor with a particle size of about 6 nm to about 400 nm.

In one embodiment, the phosphor mixture comprises a phosphor having an average particle size of about 1 nm to about 5200 nm. In another embodiment, the phosphor mixture comprises a phosphor having an average particle size of about 2 nm to about 110 nm. In yet another embodiment, the phosphor mixture comprises a phosphor having an average particle size of about 2 nm to about 21 nm. In a further embodiment, the phosphor mixture comprises a phosphor having an average particle size of about 2 nm to about 11 nm.

In one embodiment, a suitable silane functional agent for use in the disclosed methods is a saturated linear branched or unbranched compound having the nonhydrolyzed formula RₙSiM₄₋ₙ, wherein n is preferably greater than 1. Preferably, M is selected from the group consisting of a halogen, an optionally substituted alkoxy group, an optionally substituted acyloxy group, or an optionally substituted amine group. R is preferably an optionally substituted hydrocarbon group that is classified as an aliphatic group, cyclic group, or a combination of aliphatic and cyclic groups (e.g., alkaryl and aralkyl groups).

In another embodiment, the silane functional agent used in the disclosed methods has a structure represented by a formula:

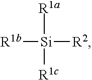

wherein each of R^{1a}, R^{1b}, and R^{1c} are independently selected from hydrogen, halogen, hydroxyl, C1-C12 alkyl, C1-C12 alkoxy, phenyl, and —O-phenyl; and wherein R² is selected from substituted C1-C60 alkyl, substituted C1-C60 alkylamine, substituted C1-C60 alkenyl, substituted C3-C60 cycloalkyl, substituted C3-C60 cycloalkenyl, and substituted C3-C60 aryl.

Suitable silane functional agents for use in the disclosed methods include, for example, 1,3-divinyltetramethyldisiloxane, 1,3-diphenyltetramethyldisiloxane, 3-aminopropyltrimethoxysilane, 3-aminopropylmethyldiethoxysilane, i-butyltriethoxysilane, i-butyltrimethoxysilane, i-propyltriethoxysilane, i-propyltrimethoxysilane, N-beta (aminoethyl) γ-aminopropyltrimethoxysilane, N-beta (aminoethyl) γ-aminopropylmethyldimethoxysilane, n-octadecyltrimethoxysilane, N-phenyl-γ-aminopropyltrimethoxysilane, n-butyltrimethoxysilane, n-propyltriethoxysilane, n-propyltrimethoxysilane, n-hexadecyltrimethoxysilane, o-methylphenyltrimethoxysilane, p-methylphenyltrimethoxysilane, tert-butyldimethylchlorosilane, a-chloroethyltrichlorosilane, beta-(3,4-epoxycyclohexyl) ethyltrimethoxysilane, beta-(3,4-epoxycyclohexyl) ethyltrimethoxysilane, beta-chloroethyltrichlorosilane, beta-(2-aminoethyl) aminopropyltrimethoxysilane, γ-(2-aminoethyl) aminopropylmethyldimethoxysilane, γ-anilinopropyltrimethoxysilane, γ-aminopropyltriethoxysilane, γ-aminopropyltrimethoxysilane, γ-glycidoxypropyltrimethoxysilane, γ-glycidoxypropylmethyldiethoxysilane, γ-glycidoxypropylmethyldimethoxysilane, γ-chloropropyltrimethoxysilane, γ-chloropropylmethyldimethoxysilane, γ-methacryloxypropyltrimethoxysilane, γ-mercaptopropyltrimethoxysilane, aminopropyltriethoxysilane, aminopropyltrimethoxysilane, allyldimethylchlorosilane, allyltriethoxysilane, allylphenyldichlorosilane, isobutyltrimethoxysilane, ethyltriethoxysilane, ethyltrichlorosilane, ethyltrimethoxysilane, octadecyltriethoxysilane, octadecyltrimethoxysilane, octyltrimethoxysilane, chloromethyldimethylchlorosilane, diethylaminopropyltrimethoxysilane, diethyldiethoxysilane, diethyldimethoxysilane, dioctyl aminopropyltrimethoxysilane, diphenyldiethoxysilane, diphenyldichlorosilane, diphenyldimethoxysilane, dibutylaminopropyldimethoxysilane, dibutylaminopropyltrimethoxysilane, dibutylaminopropylmonomethoxysilane, dipropylaminopropyltrimethoxysilane, dihexyldiethoxysilane, dihexyldimethoxysilane, dimethylaminophenyltriethoxysilane, dimethylethoxysilane, dimethyldiethoxysilane, dimethyldichlorosilane, dimethyldimethoxysilane, decyltriethoxysilane, decyltrimethoxysilane, dodecyltrimethoxysilane, triethylethoxysilane, triethylchlorosilane, triethylmethoxysilane, triorganosilyl acrylate, tripropylethoxysilane, tripropylchlorosilane, tripropylmethoxysilane, trihexylethoxysilane, trihexylchlorosilane, trimethylethoxysilane, trimethylchlorosilane, trimethylsilane, trimethylsilylmercaptan, trimethylmethoxysilane, trimethoxysilyl-γ-propylphenylamine, trimethoxysilyl-γ-propylbenzylamine, naphthyltriethoxysilane, naphthyltrimethoxysilane, nonyltriethoxysilane, hydroxypropyltrimethoxysilane, vinyldimethylacetoxysilane, vinyltriacetoxysilane, vinyltriethoxysilane, vinyltrichlorosilane, vinyltris (beta-methoxyethoxy) silane, vinyltrimethoxysilane, phenyltriethoxysilane, phenyltrichlorosilane, phenyltrimethoxysilane, butyltriethoxysilane, butyltrimethoxysilane, propyltriethoxysilane, propyltrimethoxysilane, bromomethyldimethylchlorosilane, hexamethyldisiloxane, hexyltrimethoxysilane, benzyldimethylchlorosilane, pentyltrimethoxysilane, methacryloxyethyldimethyl (3-trimethoxysilylpropyl) ammonium chloride, methyltriethoxysilane, methyltrichlorosilane, methyltrimethoxysilane, methylphenyldimethoxysilane and monobutylaminopropyltrimethoxysilane. (See, for further details, WO 2020/028889, which is incorporated herein by reference.)

In various aspects, an organofunctional silane for use as a silane functional agent in the disclosed methods comprises gamma-methacryloxypropyltrimethoxysilane. This material is available from Union Carbide Corporation under their designation A-174, from Dow Corning Corporation under their designation Z6030, from Petrarch Systems Silanes & Silicones, Bristol, Pa., under their designation M8550, or from PCR Research Chemicals, Inc., under their designation 29670-7. Many other silane functional agents are commercially available, some of which have organic groups having various degrees of reactivity and others of which are not reactive, insofar as reaction with a specific organic resin is concerned. Additional exemplary silane materials from the many available include 3-(2-Aminoethylamino)propyltrimethoxysilane, 3-Chloropropyltrichlorosilane, 3-chloropropyltrimethoxysilane, dimethyldichlorosilane, ethyltrichlorosilane, methyltrichlorosilane, methyltrimethoxysilane, phenylmethyldichlorosilane, phenyltrichlorosilane, trimethylchlorosilane, vinyltriacetoxysilane, (2-methoxyethoxy)silane, vinyl-tris(2-methoxyethoxy)silane, beta-3,(4-epoxycyclohexyl)ethyltrimethoxysilane, gamma-mercaptopropyltrimethoxysilane, gamma-aminopropyltriethoxysilane, or combinations thereof. (See, for further details, WO 2020/028889, which is incorporated herein by reference.)

In one embodiment, a suitable silane functional agent is an acrylic silane such as 3-(methacryloyloxy)propyltrimethoxysilane, 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, 3-(Acryloxypropyl)trimethoxysilane, Vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, and any combination thereof. (See, for further details, WO 2020/028889; incorporated herein by reference.)

In another embodiment, a suitable silane functional agent can be represented by the formula A-B, where the A-moiety is capable of attaching to the surface of a particle and the B-moiety is comprises alkyl, aryl, or other surface modifying chemical moieties. (See, for further details, WO 2020/028889, which is incorporated herein by reference.)

Suitable classes of surface modifying agents include, e.g., silanes, organic acids, organic bases, thiols and alcohols. For example, alkoxysilanes having the general structure (R¹)₄₋ₙ—Si—(OR²)ₙ, where n=1, 2, or 3, and chlorosilanes having the general structure (R¹)₄₋ₙ—Si—Clₙ, where n=1, 2, or 3, can be regarded as surface modifying or functional agents represented by the formula A-B, where the Si—(OR²)ₙ or Si—Clₙ reacts with the surface of the silica particle, and the R¹ modifies the nature of the surface. Non-limiting examples of useful A-B type silanes include organosilanes such as alkylchlorosilanes, alkoxysilanes, methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, butyltri methoxysilane, butyltriethoxysilane, hexyltrimethoxysilane, octyltrimethoxysilane, 3-mercaptopropyltrimethoxysilane, n-octyltriethoxysilane, phenyltriethoxysilane, polytriethoxysilane, vinyltrimethoxysilane, vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri(t-butoxy)silane, vinyltris(isobutoxy)silane, vinyltris(isopropenoxy)silane and vinyltris(2-methoxyethoxy)silane; trialkoxyarylsilanes; isooctyltrimethoxy-silane; N-(3-triethoxysilylpropyl)methoxyethoxyethoxy ethyl carbamate; N-(3-triethoxysilylpropyl)methoxyethoxyethoxyethyl carbamate; silane functional (meth)acrylates such as 3-(methacryloyloxy)propyltrimethoxysilane, 3-acryloyloxypropyltrimethoxysilane, 3-(methacryloyloxy)propyltriethoxysilane, 3-(methacryloyloxy)propylmethyldimethoxy silane, 3-(acryloyloxypropyl)methyldimethoxysilane, 3-(methacryloyloxy)propyldimethylethoxysilane, 3-(methacryloyloxy)methyltriethoxysilane, 3-(methacryloyloxy)methyltrimethoxysilane, 3-(methacryloyloxy)propyldimethyl ethoxysilane, 3-(methacryloyloxy)propenyltrimethoxysilane, 3-(methacryloyloxy)propyltrimethoxysilane; polydialkylsiloxanes such as polydimethylsiloxane; arylsilanes such as substituted and unsubstituted arylsilanes; alkylsilanes such as substituted and unsubstituted alkyl silanes, methoxy and hydroxy substituted alkyl silanes, and combinations thereof. (See, for further details, WO 2020/028889 which is incorporated herein by reference.)

D. Dispersion of a Surface-Modified Phosphor into a Matrix

The surface-modified phosphor embedded polymers may be used for converting a specific wavelength of radiation from a source such as solar spectrum or xenon lamp or LED or grow light to a desired wavelength (i.e., light conversion).

In one embodiment, the surface-modified (i.e., silica-coated and silane-functionalized) phosphor may be embedded into a polymer matrix, for example, by extruding, film casting, solving casting, bulk polymerization, and the like.

In another embodiment, the surface-modified (i.e., silica-coated and silane-functionalized) phosphor with a blue emitting agent such as POPOP may be embedded into a polymer matrix, for example, by extruding, film casting, solving casting, bulk polymerization, and the like.

The polymer matrix which may be organic, or inorganic, and may include a polymer selected from a group of thermoplastics. Examples may include, but are not limited to, the materials such as polyethylene, polypropylene, polymethyl methacrylate, polystyrene, polycarbonate, and the like.

In one embodiment, the surface-modified phosphor can be embedded into the polymer matrix, for example, by mixing the surface-modified phosphor with a polymer and preparing a phosphor embedded polymer article using the extrusion method. In another embodiment, a polymer article with the surface-modified phosphor embedded can be prepared by extrusion (e.g., sheet extrusion, blown film extrusion, coextrusion), film casting, solvent casting, bulk polymerization, or combinations thereof.

To improve photosynthesis and plant growth, the surface-modified phosphors are incorporated into the polymer matrix along with a blue emitting agent because the blue emitting agent converts a specific wavelength of radiation from a source to blue light, which is the desirable wavelength of light for photosynthesis.

In one embodiment, the blue emitting agent used for dispersion of the surface-modified (i.e., silica-coated and silane-functionalized) phosphor into a polymer matrix can be an organic or inorganic agent. In another embodiment, the blue emitting agent used for dispersion of the surface-modified phosphor into a polymer matrix can be selected from, but not limited to, POPOP, anthracene, Hoechst 33342, zinc oxide, anthracene, stilbene, zinc sulfide doped with silver (ZnS—Ag), blue emitting perovskite nanoparticles, CdTe, carbon dots, or combinations thereof. In yet another embodiment, the blue emitting agent used for dispersion of the surface-modified phosphor into a polymer matrix can be POPOP.

E. Articles

The present invention relates to the synthesis of surface-modified sulfide phosphors to address the phosphors degradation due to oxidation when exposed to environmental conditions as well as to address the issue of aggregation of sulfide phosphors when embedded into a polymer matrix.

The polymer matrix in the present invention may be organic or inorganic. The polymer matrix may be a polymer selected from a group of thermoplastics, for example, but are not limited to, the materials such as polyethylene, polypropylene, polymethyl methacrylate, polystyrene, polycarbonate, and the like.

In one embodiment, the surface-modified phosphor can be embedded into a polymer matrix. The method comprises: mixing the surface-modified phosphor with a polymer and preparing a phosphor embedded polymer article by extrusion, film casting, solving casting, or bulk polymerization. The surface-modified phosphor embedded polymer articles may be used for light conversion purposes (i.e., converting a wavelength of radiation from a source such as solar spectrum, xenon lamp or grow light to a specific and desired wavelength). A suitable resin selected from polyethylene, polymethyl methacrylate, polycarbonate, and combinations thereof, is prepared as liquid by melting or solubilizing in a suitable solvent and combined with the surface-modified phosphor, and mixed using ultrasonication, mechanical mixing, or combinations thereof. The mixture of the surface-modified phosphor in resin can be glass cast and cured at room temperature in vacuo. The surface-modified phosphor embedded polymer articles may be used for converting one or more wavelengths of radiation from a source such as solar spectrum or xenon lamp or grow light to a specific and desired wavelength (light conversion). Polymer articles made with the surface-modified phosphor prepared using the disclosed methods herein are stable and contain uniform dispersion of particles.

In another embodiment, the surface-modified phosphor with a blue emitting agent can be embedded into a polymer matrix. The method comprises: mixing the surface-modified phosphor with a polymer and a blue emitting agent such as POPOP; and preparing a surface-modified phosphor embedded polymer article by extrusion, film casting, solving casting, or bulk polymerization. A suitable resin selected from polyethylene, polymethyl methacrylate, polycarbonate, and combinations thereof, is prepared as liquid by melting or solubilizing in a suitable solvent and combined with the surface-modified phosphor and a blue emitting agent, and mixed using ultrasonication, mechanical mixing, or combinations thereof. The mixture of the surface-modified phosphor with a blue emitting agent in resin can be glass cast and cured at room temperature in vacuo. The surface-modified phosphor with a blue emitting agent embedded polymer articles may be used for converting one or more wavelengths of radiation from a source such as solar spectrum or xenon lamp or grow light to a specific and desired wavelength (light conversion). Polymer articles made with the surface-modified phosphor and the blue emitting agent prepared using the disclosed methods are stable and contain uniform dispersion of particles. And an additional advantage of these polymer articles with the blue emitting agent is that they can further increase the desirable wavelength of light available for plants, which in turn can lead to enhanced photosynthesis and increased crop yield.

In another embodiment, the polymer matrix can be derived from any suitable polymer, mixture of polymers, or polymer blend for preparing a transparent or translucent sheet, film, panel, component, or structure. In yet another embodiment, the polymer matrix is a thermoplastic polymer. In a further embodiment, the matrix material comprises a polyurethane, a polyether, a polyethylene terephthalate (PET), a polyethylene naphthalate (PEN), a cycloolefin polymer, a polyimide (PI), a polyethersulfone (PES), a polyethylene, a polyacrylate, a polycarbonate, a polystyrene, or combinations thereof. In a still further embodiment, the polyacrylate can comprise poly(methyl) methacrylate. In another embodiment, the polymer matrix is selected form polyethylene, polypropylene, polymethyl methacrylate, polystyrene, polycarbonate, and combinations thereof. In yet another embodiment, the polymer matrix is selected form polyethylene, polymethyl methacrylate, polycarbonate, and combinations thereof.

In one embodiment, a polymer matrix-phosphor composition comprises a polymer matrix and a surface-modified phosphor, wherein the polymer matrix is present in an amount of about 50 wt % to about 99.99 wt %; wherein the surface-modified phosphor is present in an amount of about 0.01 wt % to about 50 wt %; and wherein the weight percent is based on the weight of the polymer matrix and the surface-modified phosphor. In another embodiment, a polymer matrix-phosphor composition comprises a polymer matrix and a surface-modified phosphor, wherein the polymer matrix is present in an amount of about 90 wt % to about 99.9 wt %; wherein the surface-modified phosphor is present in an amount of about 0.1 wt % to about 10 wt %; and wherein the weight percent is based on the weight of the polymer matrix and the surface-modified phosphor. In yet another embodiment, a polymer matrix-phosphor composition comprises a polymer matrix and a surface-modified phosphor, wherein the polymer matrix is present in an amount of about 95 wt % to about 99.5 wt %; wherein the surface-modified phosphor is present in an amount of about 0.5 wt % to about 5 wt %; and wherein the weight percent is based on the weight of the polymer matrix and the surface-modified phosphor. In a further embodiment, a polymer matrix-phosphor composition comprises a polymer matrix and a surface-modified phosphor, wherein the polymer matrix is present in an amount of about 92.5 wt % to about 99.5 wt %; wherein the surface-modified phosphor is present in an amount of about 0.5 wt % to about 7.5 wt %; and wherein the weight percent is based on the weight of the polymer matrix and the surface-modified phosphor. (See, for further details, WO 2020/028889; incorporated herein by reference.)

In one embodiment, a polymer matrix-phosphor composition comprises a polymer matrix, a surface-modified phosphor, and a blue emitting agent, wherein the polymer matrix is present in an amount of about 50 wt % to about 99.9 wt %; wherein the disclosed surface-modified phosphor is present in an amount of about 0.0001 wt % to about 50 wt %; wherein a blue emitting agent is present in an amount of about 0.001 wt % to about 30 wt %; and wherein the weight percent is based on the weight of the polymer matrix and the surface-modified phosphor. In another embodiment, a polymer matrix-phosphor composition comprises a polymer matrix, a surface-modified phosphor, and a blue emitting agent, wherein the polymer matrix is present in an amount of about 90 wt % to about 99.9 wt %; wherein the surface-modified phosphor is present in an amount of about 0.01 wt % to about 10 wt %; wherein a blue emitting agent is present in an amount of about 0.005 wt % to about 5 wt %; and wherein the weight percent is based on the weight of the polymer matrix and the surface-modified phosphor. In yet another embodiment, a polymer matrix-phosphor composition comprises a polymer matrix, a surface-modified phosphor, and a blue emitting agent, wherein the polymer matrix is present in an amount of about 95 wt % to about 99.5 wt %; wherein the surface-modified phosphor is present in an amount of about 0.05 wt % to about 5 wt %; wherein a blue emitting agent is present in an amount of about 0.01 wt % to about 1 wt %; and wherein the weight percent is based on the weight of the polymer matrix and the surface-modified phosphor. In a further embodiment, a polymer matrix-phosphor composition comprises a polymer matrix, a surface-modified phosphor, and a blue emitting agent, wherein the polymer matrix is present in an amount of about 92.5 wt % to about 99.5 wt %; wherein the surface-modified phosphor is present in an amount of about 0.5 wt % to about 7.5 wt %; wherein a blue emitting agent is present in an amount of about 0.05 wt % to about 0.5 wt %; and wherein the weight percent is based on the weight of the polymer matrix and the surface-modified phosphor.

In one embodiment, the polymer matrix-phosphor (i.e., surface-modified phosphor) composition can be used to form a film having a thickness of about 1 mil to about 20 mil. In another embodiment, the polymer matrix-phosphor composition can be used to form a film having a thickness of about 5 mil to about 15 mil. In a further embodiment, the polymer matrix-phosphor composition can be used to form a film having a thickness of about 10 mil to about 15 mil.

In one embodiment, the polymer matrix-phosphor (i.e., surface-modified phosphor) composition comprising polyethylene, polymethyl methacrylate, polycarbonate, and combinations thereof, and the surface-modified phosphor can be used to form a film having a thickness of about 1 mil to about 20 mil. In another embodiment, the polymer matrix-phosphor composition comprising polyethylene, polymethyl methacrylate, polycarbonate, and combinations thereof, and a disclosed surface-modified phosphor can be used to form a film having a thickness of about 5 mil to about 15 mil. In yet another embodiment, a disclosed polymer matrix-phosphor composition comprising polyethylene, polymethyl methacrylate, polycarbonate, and combinations thereof, and a surface-modified phosphor can be used to form a film having a thickness of about 10 mil to about 15 mil.

In a further embodiment, the polymer matrix-phosphor-blue emitting agent (i.e., surface-modified phosphor) composition comprising polyethylene, polymethyl methacrylate, polycarbonate, and combinations thereof; a disclosed surface-modified phosphor; and a blue emitting agent can be used to form a film having a thickness of about 1 mil to about 20 mil. In another embodiment, the polymer matrix-phosphor-blue emitting agent composition comprising polyethylene, polymethyl methacrylate, polycarbonate, and combinations thereof; a disclosed surface-modified phosphor; and a blue emitting agent can be used to form a film having a thickness of about mil to about 15 mil. In yet another embodiment, the polymer matrix-phosphor-blue emitting agent composition comprising polyethylene, polymethyl methacrylate, polycarbonate, and combinations thereof; a disclosed surface-modified phosphor; and a blue emitting agent can be used to form a film having a thickness of about 10 mil to about 15 mil.

In some embodiments, a disclosed article comprises a first film comprising a foregoing film laminated to a second film without a disclosed surface-modified phosphor. In other embodiments, a disclosed article comprises a plurality of films laminated to one another, wherein each layer of the laminated film is selected from a foregoing film comprising a disclosed surface-modified phosphor, a film comprising a disclosed surface-modified phosphor and a blue emitting agent, a film comprising a disclosed polymer matrix with a blue emitting agent and without a disclosed surface-modified phosphor, and a film comprising a disclosed polymer matrix without a blue emitting agent and without a disclosed surface-modified phosphor, and combinations thereof.

In one embodiment, the disclosed polymer matrix-phosphor (i.e., surface-modified phosphor) composition prepared by the disclosed methods can be used to prepare an article, such as a film, a sheet, or a panel that is used in greenhouse glazing. In another embodiment, the luminescent article is a polyethylene film comprising a disclosed composition prepared by the disclosed methods. The film can be stapled, nailed, taped, tied, and attached by other locking systems to frames ranging from wood to steel and aluminum. Because polyethylene film is relatively inexpensive, its use has become widespread to the point of overwhelming dominance, particularly in commercial greenhouses where appearance is not a major concern.

In some embodiments, the disclosed article comprises a panel, e.g., a glass panel or panel comprising a polymer matrix such as polycarbonate, that can be used in the fabrication of greenhouse glazing, wherein a disclosed polymer matrix-phosphor composition is cast or formed in situ directly on at least one surface of the panel.

In a further embodiment, the greenhouse glazing can comprise a single-thickness aliphatic polyurethane film comprising a disclosed composition prepared by the disclosed methods that is heat-bonded to a nylon body. In another embodiment, the structure is a commercial greenhouse having walls formed of tubes of aliphatic polyurethane film. The tubes are stretched to form an approximately one-inch insulative air space between the sides of the tubes. In yet another embodiment, the structure is a residential lean-to greenhouse. In yet another embodiment, advantage is taken of the surprisingly low gas permeability of the aliphatic thermoplastic polyurethanes, particularly the polyesters, and the structure is formed with both glazing and permanently inflated air tubes of the material. Air tubes having a diameter of from one to three inches have been found to provide adequate support, and also provide ideal spacing of double layer glazing.

Numerous variations in the glazing system of the present disclosure, within the scope of the appended claims, will occur to those skilled in the art in light of the foregoing disclosure. For example, the thickness of the film comprising a disclosed composition prepared by the disclosed methods may be varied considerably. Not only polyester thermoplastic aliphatic polyurethanes may be used, but also polyether thermoplastic aliphatic polyurethanes and coextrusions of the two. For some applications, the polyurethane may be alloyed with other polymers to provide advantages of both; for example, a harder material may be provided by alloying with a polymethyl methacrylate (acrylic).

F. Greenhouse Systems and Glazing

In a further embodiment, the present invention also relates to greenhouse systems comprising an article comprising a disclosed composition prepared by the disclosed methods. In some embodiments, the greenhouse system, comprises a greenhouse glazing wherein at least part of the greenhouse glazing comprises an article, such as a sheet, a film, or a panel, comprising a disclosed composition prepared by the disclosed methods. In various embodiments, the disclosed greenhouse system can further comprise at least one plant culture.

As used herein, the term “greenhouse system” includes all types of translucent constructions such as, for example, greenhouses, glasshouses, hothouses, film tunnels or combinations thereof, that permit the protected cultivation of plants preferably comprising at least one plant culture. In this context, the greenhouse system can comprise at least one, but also a plurality of various translucent constructions that are connected to each other in some manner, for example, by passages, corridors, tunnels, doors, gates, or locks. The individual translucent constructions that permit the protected cultivation of plants can be in the form of, for example, individual structures (each with four exposed walls), serial structures (with at least one shared partition between two adjacent constructions) or block structures (as contiguous blocks with exterior walls, but without partitions between adjacent constructions).

A plant culture as set forth in accordance with an exemplary aspect of the present disclosure encompasses at least one plant, but preferably two or more preferably adjacent plants, that are being cultivated. In this context, a plant culture can also comprise different or preferably identical plants.

Moreover, the greenhouse system can also comprise several identical or preferably, different plant cultures.

A part of the glazing of the greenhouse system as set forth herein refers to at least one section of the glazing of the greenhouse system, that is to say, for example, at least one glass sheet used for the glazing. Thus, terms like “a part of the glazing” as set forth herein especially preferably refer to the roof glazing of the greenhouse system or to a part thereof.

A part of the glazing of the greenhouse system as set forth herein can amount to preferably at least 5%, preferably at least 10%, also preferably at least 15%, also preferably at least 20%, also preferably at least 25%, also preferably at least 30%, also preferably at least 35%, also preferably at least 40%, also preferably at least 45%, especially preferably at least 50% of the glazing and especially of the roof glazing of the greenhouse system.

A part of the glazing of the greenhouse system as set forth herein can amount to up to 55%, preferably up to 60%, also preferably up to 65%, also preferably up to 70%, also preferably up to 75%, also preferably up to 80%, also preferably up to 85%, also preferably up to 90%, also preferably up to 95%, especially preferably up to 100% of the glazing and especially of the roof glazing of the greenhouse system.

In addition to the general description of the embodiments, the following Examples describe some additional aspects of the present invention. While aspects of the present invention are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following specific examples are to be construed as merely illustrative, and not limitative of the remainder of the disclosure in any way whatsoever. Without further elaboration, it is believed that one skilled in the art can, based on the description herein, utilize the present invention to its fullest extent.

### Example 1. Synthesis of a CaS:Eu²⁺ Phosphor

Europium doped calcium sulfide (CaS:Eu²⁺) phosphor was synthesized using co-precipitation method. 2 mol % europium doped CaS phosphor was prepared as follows: (a) 0.98 mmol calcium nitrate tetrahydrate, 0.02 mmol europium chloride hexahydrate, 1.5 mmol thiourea, 0.02 mmol cetyltrimethylammonium bromide were dissolved in 0.25 mmol dimethyl sulfoxide using ultrasonication bath; (b) once the reactants were well dissolved, the mixture was then heated at 140° C. for 5-7 hours; (c) then the mixture was cooled at room temperature; (d) particles were separated using high speed centrifuge; (e) the resultant particles were then washed with 99.98% of acetone to remove unreacted precursors; (f) washed particles were then dried in a vacuum furnace at 60° C.; (g) the dried particles were ground with a mortar and pestle; (h) the particles were then fired at 900° C. for 6-8 hours under reducing atmosphere; and (i) the particles were cooled at room temperature and ground with a mortar and pestle and transferred to a vial and stored at room temperature under dry conditions.

FIG. 3 shows a X-ray diffraction pattern of CaS:Eu²⁺ phosphor particles, prepared as described above. And FIG. 4 shows photoluminescence emission and excitation CaS:Eu²⁺ phosphor. Inset shows that CaS:Eu²⁺ phosphor is red emitting under UV light.

### Example 2. Preparation of a Silica-Coated CaS:Eu²⁺ Phosphor

Silica coating of CaS:Eu²⁺ phosphor, prepared as described above, was performed using reverse micelles method. Igepal CO-520 and cyclohexane were used to prepare the micelle. 2 g of CaS:Eu phosphor was added to 10 ml Igepal CO-520 and 150 ml cyclohexane micelle and dispersed using ultrasonication. The mixture was further dispersed using ultrasonication for 1 hour at room temperature, followed by addition of ammonia water and tetraethyl orthosilicate (TEOS) under vigorous stirring for 15 minutes. The mixture was further allowed to react for 6 hours at room temperature with magnetic stirring. Finally, the coated particle was separated using high speed centrifuge.

### Example 3. Preparation of a Silane Functionalization of a Silica-Coated CaS:Eu²⁺ Phosphor (Surface-Modified Phosphor)

1 g of silica-coated CaS: Eu²⁺ phosphor, prepared as described above, was dispersed in 15 ml ethanol using ultrasonication to prepare a silica-coated CaS:Eu phosphor/ethanol mixture. In another beaker, 800 μl of silane functional agent (e.g., 3-methacryloxypropyltrimethoxysilane) was prehydrolyzed for 2 hours in an acidic water with pH ranging from 3 to 5.0 at room temperature. After adjusting the pH, the silane solution was added to the silica-coated phosphor/ethanol mixture under continuous magnetic stirring. This mixture was further stirred using a magnetic stirrer for additional 5 hours. Finally, the silane-functionalized and silica-coated CaS:Eu phosphor was isolated from the reaction mixture using centrifugation and washed with 99.99% ethanol. The powder form of the silane-functionalized and silica-coated CaS:Eu phosphor was obtained by drying in a vacuum furnace at 90° C.

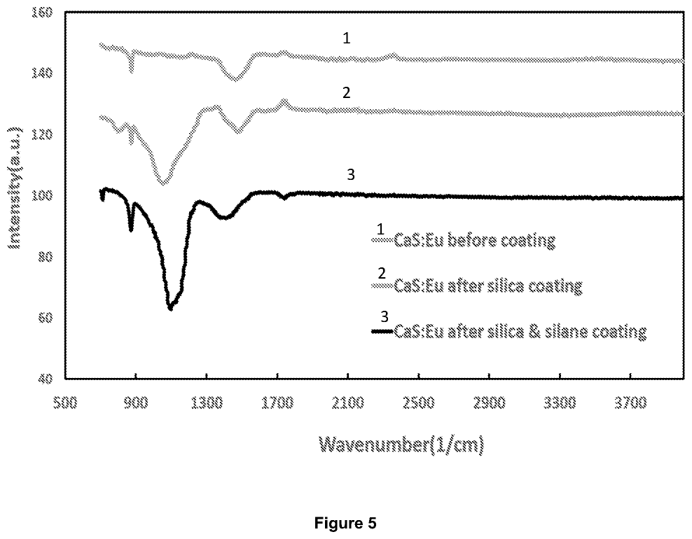

FIG. 5 illustrates FTIR spectra of CaS:Eu²⁺ phosphor before and after coating. And Si-o-Si bonds between 1000-1300 cm⁻¹ in the FTIR spectra of coated phosphor show silica and silane bonding on the phosphor.

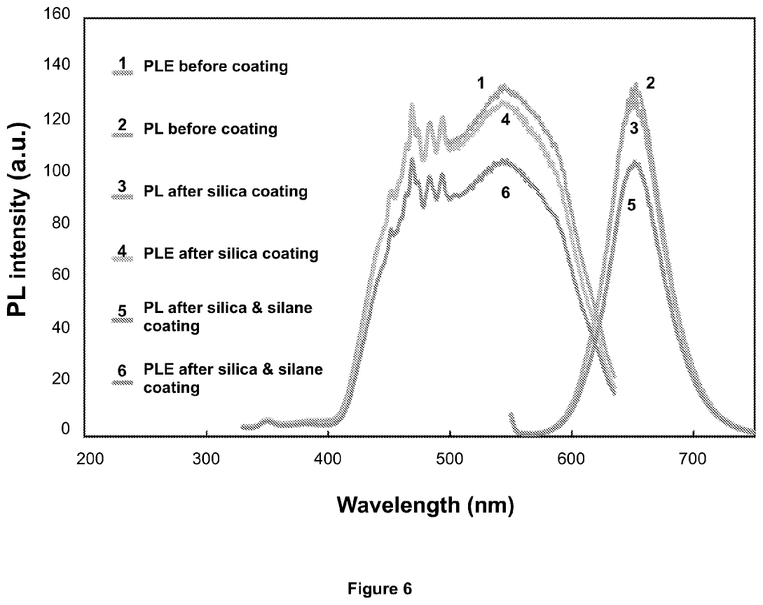

FIG. 6 illustrates photoluminescence emission (PL) and excitation (PLE) spectra of CaS:Eu²⁺ phosphor before and after coating with silica and silane. There is no significant reduction in the luminescent properties of the phosphor during the coating process.

### Example 4. Preparation and Testing of a Disclosed Article

Three combinations of the phosphors, prepared as described above, were tested: (a) silica-coated phosphor; (b) silica-coated and silane-functionalized phosphor; and (c) silica-coated and silane-functionalized phosphor with blue emitting agent POPOP.

A. Dispersion of a Silica-Coated CaS:Eu²⁺ Phosphor in a Polymer Film

The silica-coated phosphor (CaS:Eu²⁺), prepared as described above, was added to a polymer blend comprising acrylic resins at a level of 0.1 wt % of the silica-coated phosphor based on the total weight of the resin blend and the silica-coated phosphor. The silica-coated phosphor was dispersed in the resin blend by mechanical stirring. A control composition comprising the same acrylic resin blend was prepared using an uncoated phosphor, i.e., the CaS:Eu phosphor prepared as described above, but not treated with the tetraethyl orthosilicate. Polymer test films were obtained by casting the resin into a glass container and drying under vacuum at room temperature.

B. Dispersion of a Surface-Modified (Silica-Coated and Silane-Functionalized) CaS:Eu²⁺ Phosphor in a Polymer Film

The surface-modified phosphor (i.e., silica-coated and silane-functionalized CaS:Eu²⁺), prepared as described above, was added to a polymer blend comprising acrylic resins at a level of 0.1 wt % of the surface-modified phosphor based on the total weight of the resin blend and the surface-modified phosphor. The surface-modified phosphor was dispersed in the resin blend by mechanical stirring. Control compositions comprising the same acrylic resin blend were prepared using (i) silica-coated phosphor and (i) non-functionalized and uncoated phosphor, i.e., the phosphor prepared as described above, but not treated with silica and/or silane. Polymer test films were obtained by casting the resin into a glass container and drying under vacuum at room temperature.

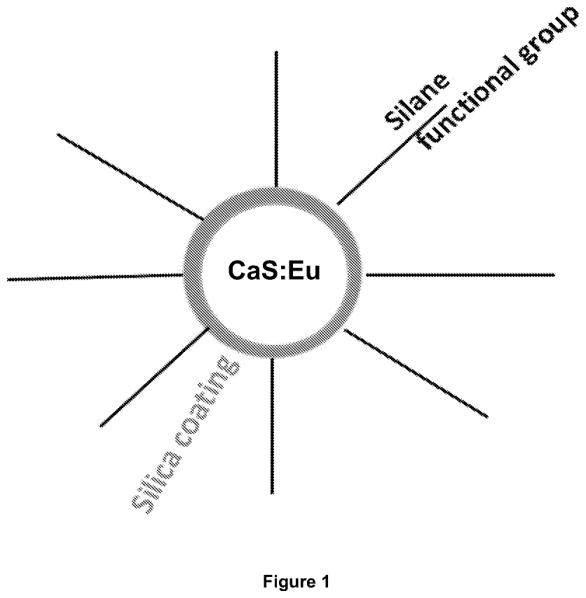

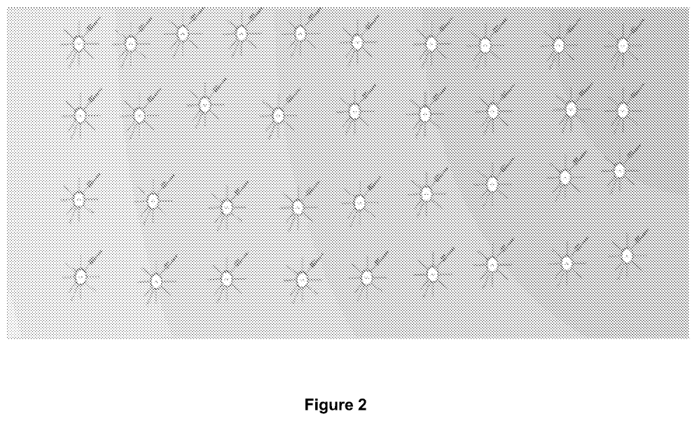

FIG. 1 shows a schematic representation of a surface-modified (i.e., silica coating and silane functionalization) CaS:Eu²⁺ phosphor, and FIG. 2 shows a schematic representation of dispersion and incorporation of the surface-modified CaS:Eu²⁺ phosphor into a greenhouse plastic through extrusion.

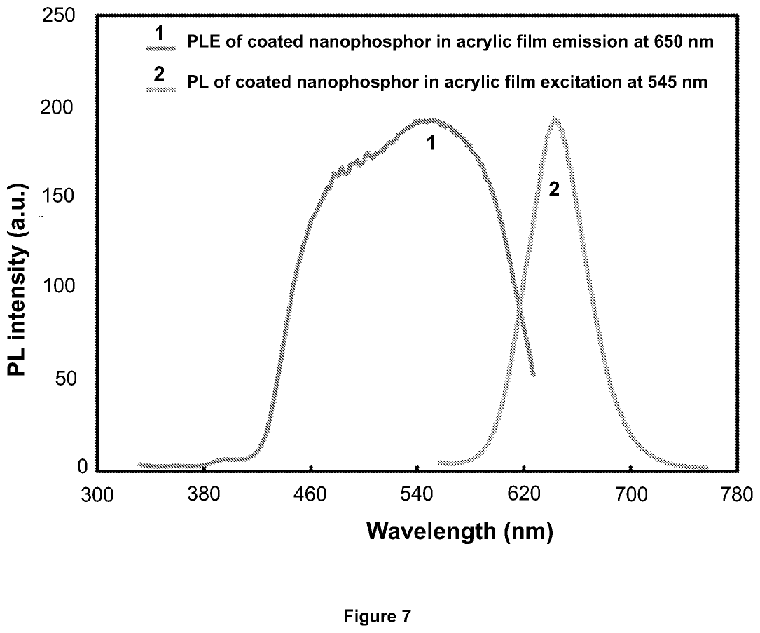

FIG. 6 illustrates photoluminescence emission (PL) and excitation (PLE) spectra of CaS:Eu²⁺ phosphor before and after coating with silica and functionalization with silane. The data show that a phosphor (CaS:Eu) coated with silica and functionalized with silane has similar excitation or emission characteristics compared to an uncoated control phosphor. And there is no significant reduction in luminescent properties during the coating process. Moreover, as shown in FIG. 7, the desired photoluminescence of the coated phosphor was maintained after dispersed in the article, i.e., dispersed silica-coated and silane-functionalized phosphor in an acrylic film.

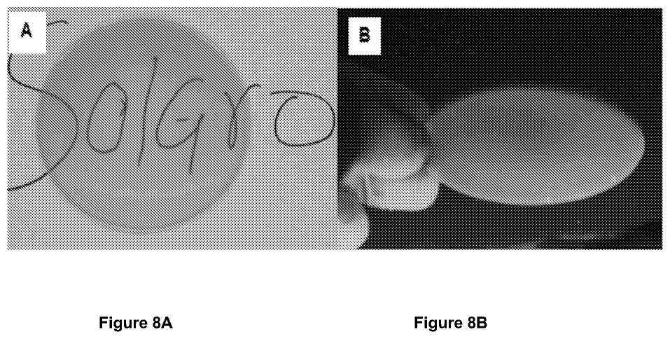

Further, as shown in FIGS. 8A-8B, the surface-modified (i.e., silica-coated and silane-functionalized) CaS:Eu²⁺ phosphor retains the desired photoluminescence properties of the CaS:Eu²⁺ phosphor. FIG. 8A shows that under ambient room light, the silica-coated and silane-functionalized CaS:Eu²⁺ phosphor evenly distributed in a solid acrylic film, and FIG. 8B shows evenly distributed photoluminescence of the surface-modified phosphor in the same solid acrylic film under UV light.

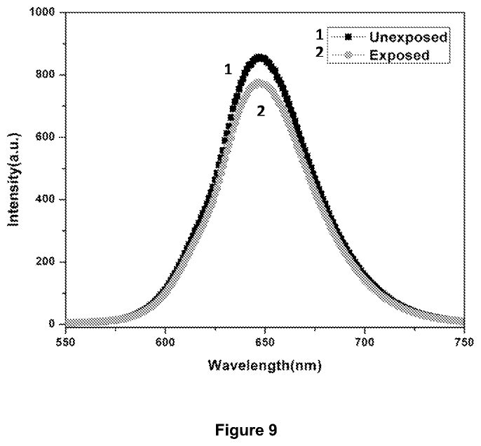

FIG. 9 shows photoluminescence of surface-modified CaS:Eu²⁺ phosphor particles before and after 1500 hr (equivalent to 1.5 years) of Xenon-arc weathering test. The weathering test reproduces the damage caused by sunlight, rain, and dew. And the test shows that the photoluminescence of the coated phosphor (CaS:Eu) was maintained with only about 10% decrease in photoluminescence, showing the high stability of surface-modified CaS:Eu²⁺ phosphor particles under continuous environmental exposure.

C. Dispersion of a Surface-Modified (Silica-Coated and Silane-Functionalized) CaS:Eu²⁺ Phosphor with POPOP in a Polymer Film

The surface-modified phosphor (i.e., silica-coated and silane-functionalized CaS:Eu²⁺), prepared as described above, was added along with 0.01 wt % of a blue emitting agent POPOP to a polymer blend comprising acrylic resins at a level of 0.1 wt % of the surface-modified phosphor based on the total weight of the resin blend and the surface-modified phosphor. The surface-modified phosphor was dispersed in the resin blend by mechanical stirring.

Control compositions comprising the same acrylic resin blend were prepared using (i) phosphor alone, before silica coating and silane functionalization, (i.e., the CaS:Eu²⁺ phosphor prepared as described above, but not treated with silica and/or silane) and without adding POPOP; (ii) surface-modified phosphor, without adding POPOP; and (iii) POPOP alone, without phosphor. Polymer test films were obtained by casting the resin into a glass container and drying under vacuum at room temperature.

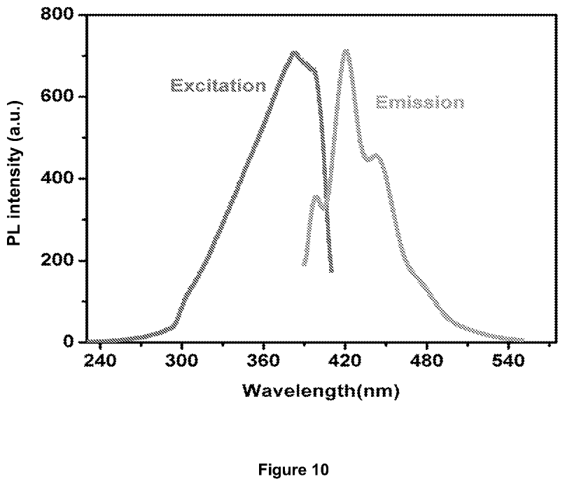

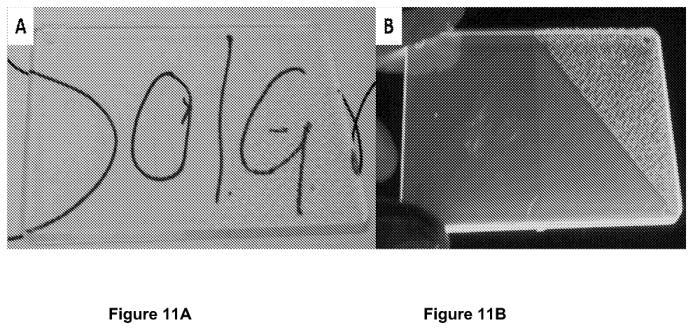

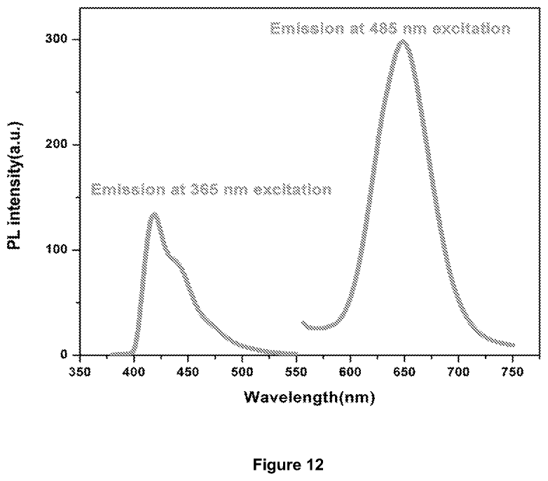

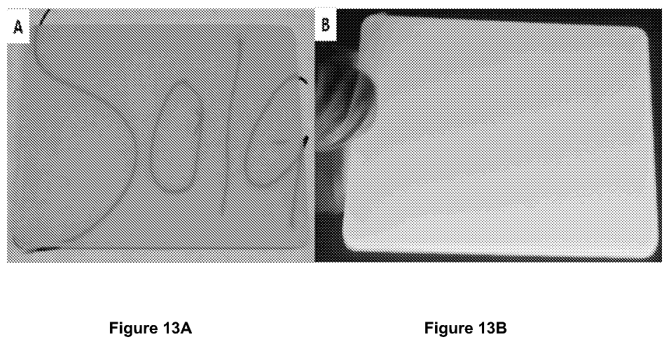

FIG. 10 illustrates photoluminescence emission (PL) and excitation (PLE) spectra of blue emitting agent POPOP in a polymer film. FIG. 11A shows that under ambient room light, POPOP is evenly distributed in a solid acrylic film, and FIG. 11B shows photoluminescence of the same solid acrylic film under UV light. Further, POPOP shows similar emission characteristics when embedded in a polymer film with the silica-coated and silane-functionalized CaS:Eu²⁺ phosphor. (See FIG. 12.) Moreover, POPOP did not affect the photoluminescence and emission characteristics of the silica-coated and silane-functionalized CaS:Eu²⁺ phosphor. (See FIGS. 7 and 12.) Furthermore, as shown in FIGS. 13A-13B, the silica-coated and silane-functionalized CaS:Eu²⁺ phosphor and POPOP retain the desired photoluminescence properties of the CaS:Eu²⁺ phosphor. FIG. 13A shows that under ambient room light, the silica-coated and silane-functionalized CaS:Eu²⁺ phosphor and POPOP are evenly dispersed in a solid acrylic film, and FIG. 13B shows photoluminescence, of the same acrylic film under UV light.

Although the invention has bee explained in relation to its various embodiments, it is to be understood that many other possible modifications and variations can be made without departing from the spirit and scope of the invention as hereinafter claimed.

1. A method of preparing a phosphor comprising:
(a) preparing a phosphor reaction mixture comprising
i. a salt material selected from a group consisting of calcium salts, strontium salts, cadmium salts, zinc salts, copper salts, manganese salts, terbium salts, and combinations thereof,
ii. a sulfur compound selected from a group consisting of thiols, elemental sulfur, thioesters, sulfur halide, and combinations thereof,
iii. a rare earth element selected from a group consisting of selected from Eu, Tb, Ce, Dy, Sm, Yb, Er, and combinations thereof,
iv. a surfactant selected from a group consisting of cetyltrimethylammonium bromide, cetrimonium bromide, hexadecyltrimethylammonium bromide, alkyltrimethylammonium bromide, oleylamine, cetyltrimethylammonium chloride (CTAC), oleic acid, dimethyldioctadecylammonium chloride, and mixtures thereof, and
v. a solvent selected from a group consisting of dimethyl sulfoxide, dimethylformamide, tetrahydrofuran, ethyl acetate, acetonitrile, propylene carbonate and mixtures thereof;
(b) heating the phosphor reaction mixture at a temperature of about 50° C. to about 200° C. for a period of time of about 1 hour to about 24 hours;
(c) isolating the phosphor particles from the phosphor reaction mixture;
(d) drying the phosphor particles by heating the isolated phosphor particles at a temperature of about 30° C. to about 120° C. for a period of time of about 30 minutes to about 24 hours;
(e) micronizing, grinding, or combinations thereof to provide a phosphor with a particle size of about 1 nm to about 1000 nm; and.
(f) firing the dried phosphor particles by heating the isolated phosphor particles at a temperature of about 300° C. to about 1000° C. under reducing atmosphere for a period of time of about 1 hour to about 20 hours.

2. (canceled)

3. The method of claim 1, wherein the salt material comprises calcium nitrate tetrahydrate, calcium nitrate, calcium acetate, calcium chloride, calcium carbonate, strontium nitrate, strontium chloride, strontium acetate, acetate, zinc nitrate, zinc chloride, zinc acetate, copper chloride, copper nitrate, copper acetate, cadmium nitrate, cadmium chloride, manganese nitrate, manganese acetate, manganese chloride, terbium nitrate, terbium chloride, terbium acetate, and combinations thereof.

4-5. (canceled)

6. The method of claim 1, wherein the sulfur compound in the phosphor reaction mixture comprises thiourea, sulfur powder, thioacetamide, allyl sulfide, thiophene, allyl isothiocyanate, and combinations thereof.

7-8. (canceled)

9. The method of claim 1, wherein the rare earth element is europium chloride hexahydrate.

10-13. (canceled)

14. The method of claim 1, further comprises washing the phosphor particles with acetone, ethanol, isopropyl alcohol, and mixtures thereof.

15-17. (canceled)

18. A method of preparing a surface-modified phosphor comprising:
(g) preparing a surface-coated phosphor comprising;
i. preparing a micelle with a surfactant and an alkane;
ii. preparing phosphor mixture comprising about 1 g/L to about 200 g/L of a phosphor and a micelle with a surfactant and an alkane;
iii. preparing a surface-coating solution comprising a silicate, ammonia, and water;
iv. preparing a surface-coating phosphor reaction mixture by mixing the phosphor mixture and the surface-coating solution;
v. stirring the surface-coating phosphor reaction mixture at room temperature; and
vi. isolating the surface-coated phosphor particles; and
(h) preparing a functionalized surface-coated phosphor comprising:
i. preparing the surface-coated phosphor mixture comprising the surface-coated phosphor and an alcohol, wherein 1 g/L to about 200 g/L of the surface-coated phosphor is in the alcohol;
ii. preparing a functionalization solution comprising a silane functional agent and acidic water;
iii. preparing a functionalization surface-coated phosphor reaction mixture by mixing the surface-coated phosphor mixture and the functionalization solution and stirring for about 4 hours to about 8 hours;
iv. isolating the functionalized surface-coated phosphor particles from the functionalization surface-coated phosphor reaction mixture; and
v. drying the isolated functionalized surface-coated phosphor particle;
wherein the phosphor is the phosphor prepared by the method of claim 1; and
wherein the surface-modified phosphor has a photoluminescence intensity of about 0.1 to about 1.0 that of the same phosphor that has not been subjected to the method.

19. The method of claim 18, wherein the phosphor is a silicate phosphor, an aluminate phosphor, a nitride phosphor, an oxynitride phosphor, a sulfide phosphor, an oxysulfide phosphor, or mixtures thereof.

20. The method of claim 19, wherein the phosphor is a sulfide phosphor comprising sulfur, a metal selected from calcium, strontium, cadmium, zinc, copper, a rare earth element selected from Eu, Tb, Ce, Dy, Sm, Yb, Er and combinations thereof.

21-22. (canceled)

23. The method of claim 20, wherein the sulfide phosphor is (Ca, Sr, Ba)(AI, In, Ga)₂S₄:Eu, (Ca, Sr)S:Eu, CaS:Eu, (Zn, Cd)S:Eu:Ag, or combinations thereof.

24. (canceled)

25. The method of claim 18, wherein the surfactant in the micelle is Igepal CO-520, Igepal CA-630, Triton X-100, Tween, polybenzene compounds, polyoxyethylene alkyl ethers, polyglycerol alkyl ethers, lauryl glucoside, decyl glucoside, n-dodecyl-b-D-maltoside, Zonyl FSO, lauric acid, oleic acid, digitonin, poloxamer, lauramide monoethylamine, aluramide diethylamine, Nonoxynol 9, glycerol monolayrate, pentapropylene glycol monododecyl ether, octapropylene glycol monododecyl ether, pentaethylene glycol monododecyl ether, octaethylene glycol monododecyl ether, or mixtures thereof.

26. The method of claim 18, wherein the alkane is cyclopropane, cyclobutane, cyclopentane, cyclohexane, cycloheptane, cyclooctane, cyclononane, cyclodecane, or mixtures thereof.

27. (canceled)

28. The method of claim 18, wherein the silica is silicon dioxide, sodium silicate, potassium silicate, diethylsilicate, methyl orthosilicate, ethyl orthosilicate, tetraethyl orthosilica (TEOS), tetramethyl orthosilicate, tetrapropyl orthosilicate, diethyl dimethyl orthosilicate, diethyl bis(trimethylsilyl) orthosilicate, sodium orthosilicate, potassium orthosilicate, or mixtures thereof.

29. (canceled)

30. The method of claim 18, wherein the alcohol is methanol, ethanol, isopropyl alcohol, propanol, butanol, or mixtures thereof.

31-32. (canceled)

33. The method of claim 18, wherein the silane has a structure represented by a formula: 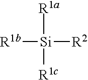
wherein each of R¹a, R¹b, and R¹c are independently selected from hydrogen, halogen, hydroxyl, C₁-C₁₂ alkyl, C₁-C₁₂ alkoxy, phenyl, —O-phenyl; and
wherein R² is selected from substituted C1-C60 alkyl, substituted C1-C60 alkylamine, substituted C1-C60 alkenyl, substituted C3-C60 cycloalkyl, or substituted C3-C60 cycloalkenyl, substituted C3-C60 aryl.

34. The method claim 33, wherein the silane is 1,3-divinyltetramethyldisiloxane, 1,3-diphenyltetramethyldisiloxane, 3-aminopropyltrimethoxysilane, 3-aminopropylmethyldiethoxysilane, i-butyltriethoxysilane, i-butyltrimethoxysilane, i-propyltriethoxysilane, i-propyltrimethoxysilane, N-beta (aminoethyl) γ-aminopropyltrimethoxysilane, N-beta (aminoethyl) γ-aminopropylmethyldimethoxysilane, n-octadecyltrimethoxysilane, N-phenyl-γ-aminopropyltrimethoxysilane, n-butyltrimethoxysilane, n-propyltriethoxysilane, n-propyltrimethoxysilane, n-hexadecyltrimethoxysilane, o-methylphenyltrimethoxysilane, p-methylphenyltrimethoxysilane, tert-butyldimethylchlorosilane, a-chloroethyltrichlorosilane, beta-(3,4-epoxycyclohexyl) ethyltrimethoxysilane, beta-(3,4-epoxycyclohexyl) ethyltrimethoxysilane, beta-chloroethyltrichlorosilane, beta-(2-aminoethyl) aminopropyltrimethoxysilane, γ-(2-aminoethyl) aminopropylmethyldimethoxysilane, γ-anilinopropyltrimethoxysilane, γ-aminopropyltriethoxysilane, γ-aminopropyltrimethoxysilane, γ-glycidoxypropyltrimethoxysilane, γ-glycidoxypropylmethyldiethoxysilane, γ-glycidoxypropylmethyldimethoxysilane, γ-chloropropyltrimethoxysilane, γ-chloropropylmethyldimethoxysilane, γ-methacryloxypropyltrimethoxysilane, γ-mercaptopropyltrimethoxysilane, aminopropyltriethoxysilane, aminopropyltrimethoxysilane, allyldimethylchlorosilane, allyltriethoxysilane, allylphenyldichlorosilane, isobutyltrimethoxysilane, ethyltriethoxysilane, ethyltrichlorosilane, ethyltrimethoxysilane, octadecyltriethoxysilane, octadecyltrimethoxysilane, octyltrimethoxysilane, chloromethyldimethylchlorosilane, diethylaminopropyltrimethoxysilane, diethyldiethoxysilane, diethyldimethoxysilane, dioctyl aminopropyltrimethoxysilane, diphenyldiethoxysilane, diphenyldichlorosilane, diphenyldimethoxysilane, dibutylaminopropyldimethoxysilane, dibutylaminopropyltrimethoxysilane, dibutylaminopropylmonomethoxysilane, dipropylaminopropyltrimethoxysilane, dihexyldiethoxysilane, dihexyldimethoxysilane, dimethylaminophenyltriethoxysilane, dimethylethoxysilane, dimethyldiethoxysilane, dimethyldichlorosilane, dimethyldimethoxysilane, decyltriethoxysilane, decyltrimethoxysilane, dodecyltrimethoxysilane, triethylethoxysilane, triethylchlorosilane, triethylmethoxysilane, triorganosilyl acrylate, tripropylethoxysilane, tripropylchlorosilane, tripropylmethoxysilane, trihexylethoxysilane, trihexylchlorosilane, trimethylethoxysilane, trimethylchlorosilane, trimethylsilane, trimethylsilylmercaptan, trimethylmethoxysilane, trimethoxysilyl-γ-propylphenylamine, trimethoxysilyl-γ-propylbenzylamine, naphthyltriethoxysilane, naphthyltrimethoxysilane, nonyltriethoxysilane, hydroxypropyltrimethoxysilane, vinyldimethylacetoxysilane, vinyltriacetoxysilane, vinyltriethoxysilane, vinyltrichlorosilane, vinyltris (beta-methoxyethoxy) silane, vinyltrimethoxysilane, phenyltriethoxysilane, phenyltrichlorosilane, phenyltrimethoxysilane, butyltriethoxysilane, butyltrimethoxysilane, propyltriethoxysilane, propyltrimethoxysilane, bromomethyldimethylchlorosilane, hexamethyldisiloxane, hexyltrimethoxysilane, benzyldimethylchlorosilane, pentyltrimethoxysilane, methacryloxyethyldimethyl (3-trimethoxysilylpropyl) ammonium chloride, methyltriethoxysilane, methyltrichlorosilane, methyltrimethoxysilane, methylphenyldimethoxysilane, monobutylaminopropyltrimethoxysilane, or mixtures thereof.

35. (canceled)

36. The method of claim 18, wherein the functionalization solution comprises about 0.01 g/L to about 100 g/L of the silane based on the total volume of the functionalization solution and a pH of about 1 to about 6.

37-39. (canceled)

40. The method of claim 18, wherein the functionalization surface-coated phosphor reaction mixture has weight ratio of the silane to the surface-coated phosphor of about 0.001:1 to about 5:1.

41-66. (canceled)

67. An article comprising:
(i) the surface-modified nanophosphor prepared by the method of claim 18;
(j) a polymer matrix; and
(k) a blue emitting agent comprising an organic or an inorganic agent;
wherein the article is a polyethylene, a polyacrylate, a poly(methyl methacrylate), a polycarbonate, a polystyrene, polymethyl methacrylate sheet, a film, or panel comprising about 0.01 wt % to about 50 wt %, about 0.01 wt % to about 5 wt % about 0.01 wt % to about 1 wt %, or about 1 wt % to about 10 wt % of the surface-modified phosphor and about 99.99 wt % to about 50 wt %, about 99.99 wt % to about 95 wt %, about 99.99 wt % to about 99 wt %, or about 99 wt % to about 90 wt % of a matrix material, based on the total weight of the surface-modified phosphor and the matrix material.

68-71. (canceled)

72. The article of claim 67, wherein the surface-modified phosphor or nanophosphor is homogeneously dispersed throughout the matrix material using a method of extrusion, film casting, solvent casting, bulk polymerization, or combinations thereof.

73-81. (canceled)

82. The article of claim 67, wherein the blue emitting agent is 1,4-bis(5-phenyloxazol-2-yl) benzene (POPOP), zinc oxide, anthracene, stilbene, zinc sulfide doped with silver (ZnS—Ag), blue emitting perovskite nanoparticles, CdTe, carbon dots, or combinations thereof, present in an amount of about 0.001 wt % to about 30 wt %.

83-88. (canceled)
